(19) United States
(12) Patent Application Publication
(10) Pub. No.: US 2011/0182169 A1
(43) Pub. Date: Jul. 28, 2011

(54) CODE DIVISION MULTIPLEXING METHOD AND SYSTEM

(75) Inventor: Daoben Li, Shenzhen (CN)

(73) Assignee: Research Institute of Tsinghua University in Shenzhen, Shenzhen (CN)

(21) Appl. No.: 12/558,537

(22) Filed: Sep. 13, 2009

(51) Int. Cl. H04J 11/00; H04B 7/216

(52) U.S. Cl. 370/203; 370/342

(57) ABSTRACT

This invention provides a code division multiplexing method and system which include the following steps: constructing the basic grouping perfect orthogonal complementary code pair mate, modulating the C code and S code of the basic grouping perfect orthogonal complementary code pair mate to the M orthogonal carrier frequency or orthogonal polarization waves which are serially in time, and implementing continuous shift on the modulated basic grouping perfect orthogonal complementary code pair mate. The present invention's code division multiplexing method and system make each carrier signal's average time bandwidth product approach to 1 by using orthogonal multicarrier, having the code utilization rate more than 1 through the shift overlapping under the condition of keeping the property of signature sequence groups' “zero related window” and making the signature sequence word's utilization rate far greater than 1 by using shift overlapping under the condition of losing the “zero related window” property of signature sequence but keeping the property of signature sequence groups' orthogonality. Therefore, the system has greater spectrum efficiency even if just using low dimensional modulation signals.

### BACKGROUND OF THE INVENTION

1. Field of the Invention

This invention relates the field of wireless communications, in particular it's about a code division multiplexing method and system.

2. Description of the Related Art

IMT (international mobile telecommunications)-Advanced, the new standard for the future mobile communications, is currently proposed by ITU (international telecommunications union), and many International Standardization Organizations are all actively targetting the goal of future mobile communication, and scheduling the timetable for the system implementation. ITU predicts that the future system with the new standard can support the peak rate of up to 100 Mbps in the high-speed mobile and harsh transmission environment and 1 Gbps in low-speed mobile and good transmission environment and meet the needs of the global personal communications around the year 2010.

However, the frequency spectrum resources used for mobile communications are very limited. It is very difficult to meet the explosive growth of the communication traffic requirements by the current technical solutions or even the theoretical concepts with such limited resources, which requires the new innovation and breakthrough in wireless communications from the theoretical and technical perspective to solve the problems, so that the spectrum efficiency, capacity and data rate can be improved in at least one order of magnitude.

The spectral efficiency is defined as the maximum (peak) bit transmission rate each space channel can support in the system when the bandwidth of the system is given, and the metric is bps/Hz/antenna (bps/Hz/Antenna).

We know from basic information theory that for any given channel, that is, a given system bandwidth B, when emission signal power is Ps and interference signal power is PI, the largest Peak Data Rate the system can support is the channel capacity. For example, when interference is Gaussian random signal or Gaussian procedure, the system channel capacity is as follows:

$$C = B \cdot {Log}_{2} ( 1 + \frac{{P}_{S}}{{P}_{I}} )$$

The basic theory of assigning channel capacity C to Multiple addresses user is called Multi-user Information Theory. It points out that, “Waveform Division Multiple Access”, commonly known as CDMA (code division multiple access), is the optimal Multiple Access mode. It will ensure that all address users can share C instead of distributing C. But, in the “wave division multiple access” system, although each address user's Data Rate can not be bigger than C, the sum of the Data Rata is likely to exceed C. Indeed, other multiple access methods, such as Time Division Multiple Access-TDMA, Frequency Division Multiple Access-FDMA can only distribute C, meaning that, in these multiple access systems, each address user's Data Rata or the sum of the Data Rata can not exceed C. Unfortunately, the practical capacity and spectral efficiency of the traditional CDMA system is not only far below the theoretical capacity limit, but even lower than the Orthogonal Frequency Division Multiplexing-OFDM system. However, the existing CDMA systems can be managed to achieve Frequency Fully Reuse, namely, the Frequency Reuse Factor can be 1 under Network of Cell (or sector) Environment, but the capacity of residential areas near the boundary line was scaled down significantly. At present, many researchers in the field of the wireless communications feel pessimistic towards CDMA, the reason is that the traditional CDMA is a strong self-interference system, and it exists the deadly “Near Far Effect” problem so that the system spectral efficiency can not compare to OFDM. The reason for this problem mainly lies in that it uses signature sequence with bad characteristics, and so Code Efficiency (when code words in the time-bandwidth product is code length, the number of code words and code length ratio) is too little. Regardless the traditional CDMA, the current signature sequence is recognized as close to the ideal characteristics and the highest spectrum efficiency LAS-CDMA (Large Area Synchronized Code Division Multiple Access), wherein the code word can only provide for addresses codes, and Δ indicate the “Zero Correlation Window” width, bur it must be adequately bigger than the channel's maximum time-proliferation, namely, the Code Efficiency only. Unless Δ=0, the Code Efficiency can be 1, then LAS-CDMA may degrade into traditional CDMA, and traditional CDMA can only work in the AWGN (additive white Gaussian noise) channel without any fading. To be able to work in the fading channel, due to the existence of channel time-proliferation and fading, even if we force that Δ=0, its Code Efficiency can not reach 1. Meanwhile, the LAS-CDMA may not overcome its “Near Far effect” problem and lose its corresponding technological superiority, and the Anti Multi-path Interference ability may decrease as well. The greater the width of “Zero correlation window” Δ is, the more significant LAS-CDMA's technical superiority can be maintained, but Code Efficiency is also lower. The present inventor's previous invention—Grouped Multiple Access Codes with “Zero Correlation Window”—PCT/CN2006/000947, also known as DBL-CDMA code, is another kind of “zero correlation window”, namely, the “wave division multiple access” technology with its capacity and spectrum efficiency i much higher than the LAS-CDMA, but the number of available address word code as well as the width of “zero correlation window” and signature sequence Efficiency are almost irrelevant. Although the Code Efficiency for maintaining the “zero correlation window” feature may be as high as ½ or even slightly higher, it is still too low for the future requirements of wireless communications.

In addition, according to the Uncertainty Principle, the effective duration of the effective Time Bandwidth Product of any physical signal can only exceed 1, and can not be equal to 1, namely, in a given system Symbol Rate, or Chip Rate, system bandwidth B can only be wider, and can not be the theoretical minimum value. Only the orthogonal frequency multi-carrier system when the Carrier number M is very large, the total time bandwidth product of the signal can be close to M, while the average time-bandwidth product of each sub-carrier is close to 1.

The present invention combines the contents of the three previous patents by the present inventor. These three patents are: application No. PCT/CN2006/000947 with the title “a packet of time, space, frequency of Multi-address encoding method”; application No. PCT/CN2006/001585 with the title “a time division multiplexing method and system”; application No. PCT/CN2006/002012 with the title “a frequency division multiplexing methods and System”.

### SUMMARY OF THE INVENTION

The purpose of the present invention is to provide a code division multiplexing method and system, and the invention focuses on the high spectral efficiency “Overlapped Multiplexing Theory” which continues and combines the inventor's previous invention with Patent No. PCT/CN2006/000947. The implementation of overlapping shift multiplexing of signature sequence, namely Overlapped Code Division Multiplexing can achieve the substantial increase in spectral efficiency.

In order to achieve the above objectives, the present invention presents a code division multiplexing method, which includes the following steps: constructing Basic Group Perfect Complete Complementary Orthogonal Code Pairs Mate; modulating the C code and S code to M orthogonal carriers of Basic Group Perfect Complete Complementary Orthogonal Code Pairs Mate which are consecutively ordered in time; continuous shifting the modulated Basic Group Perfect Complete Complementary Orthogonal Code Pairs Mate.

The invention also provides a code division multiplexing system, and the described system includes the following devices: a group code generator for constructing Basic Group Perfect Complete Complementary Orthogonal Code Pairs Mate; a carrier modulator for modulating the C code and S code of Basic Group Perfect Complete Complementary Orthogonal Code Pairs Mate to M orthogonal carriers or M orthogonal polarization waves; a shifter for continuous shifting of the modulated Basic Group Perfect Complete Complementary Orthogonal Code Pairs Mate.

From the technology details of the invention, it can achieve the following useful technical benefits: by utilizing the code division multiplexing method and system of the invention, the average time bandwidth product of each carrier signal is close to 1 by using orthogonal multi-carrier; maintain the “zero correlation window” feature between signature sequence group, and at the same time, the Code Efficiency is bigger than 1 by using overlap shift; maintain orthogonality of the signature sequence group in the loss of“zero correlation window” between signature sequence group, and the overlap shift may enable the Code Efficiency exceed 1 so that the system can achieve a high spectral efficiency even though it uses low-dimensional modulation signal.

The code division multiplexing method and system in the present invention, can maintain “zero correlation window” feature between multi-signature sequence groups, and the system has no fatal “Near Far Effect”, therefore avoiding the use of complex rapid power control or other complex technologies;

The code division multiplexing method and system in the present invention, has lower Threshold SIR compared to other single-antenna transmission technology in the same conditions, thus saving transmission power and increasing the service radius;

The code division multiplexing method and system in the present invention uses orthogonal time frequency coding for the multi-carrier frequency group to make system frequency reuse factor rclose to 1, and reduce adjacent cell interference to zero or minimum, so that in a Network of Multi-Cell (or sector) Environment, it does not require frequency planning which greatly simplifies the system design and implementations. Besides, its cell system capacity and spectral efficiency will be much higher than any existing technology such as OFDM.

The code division multiplexing method and system in the present invention uses the design of “time, space and frequency” signature sequence expansion matrix A with automatic Implicit Diversity gain, and uses multi-carrier orthogonal frequency (or carrier group) interleaving error correction coding technology, so that when working in time-varying random channel it automatically has sufficiently large Implicit Diversity gain to improve system transmission reliability.

In summary, the present invention provides efficient, reliable, practical and innovative code division multiplexing method and system with a substantially increased communication system spectrum efficiency in Network of Cell (or sector) Environment.

### BRIEF DESCRIPTION OF THE DRAWINGS

For the full understanding of the nature of the present invention, reference should be made to the following detailed descriptions with the accompanying drawings in which:

FIG. 1: The overlapping code division multiplexing system function block diagram of the present invention;

FIG. 2: The autocorrelation function graph of Group Perfect Complete Complementary Orthogonal Code Pairs Mate B1,1 and B2,1;

FIG. 3: The autocorrelation function graph of Group Perfect Complete Complementary Orthogonal Code Pairs Mate B1,2 and B2,2;

FIG. 4: The autocorrelation function graph of Group Perfect Complete Complementary Orthogonal Code Pairs Mate B1,3 and B2,3;

FIG. 5: The autocorrelation function graph of Group Perfect Complete Complementary Orthogonal Code Pairs Mate B1,4 and B2,4;

FIG. 6: The Cross-correlation function graph of Group Perfect Complete Complementary Orthogonal Code Pairs Mate B1,12 and B2,12;

FIG. 7: The Cross-correlation function graph of Group Perfect Complete Complementary Orthogonal Code Pairs Mate B1,13 and B2,13;

FIG. 8: The Cross-correlation function graph of Group Perfect Complete Complementary Orthogonal Code Pairs Mate B1,14 and B2,14;

FIG. 9: The Cross-correlation function graph of Group Perfect Complete Complementary Orthogonal Code Pairs Mate B1,23 and B2,23;

FIG. 10: The Cross-correlation function graph of Group Perfect Complete Complementary Orthogonal Code Pairs Mate B1,24 and B2,24;

FIG. 11: The Cross-correlation function graph of Group Perfect Complete Complementary Orthogonal Code Pairs Mate B1,34 and B2,34;

FIG. 12: The Cross-correlation function graph of Group Perfect Complete Complementary Orthogonal Code Pairs Mate;

FIG. 13: The Basic Group Perfect Complete Complementary Orthogonal Code Pairs Mate scheme with relative shift when the overlapping multiplicity I is 2;

FIG. 14: The Basic Group Perfect Complete Complementary Orthogonal Code Pairs Materank in time division multiplexing mode schema when the overlapping multiplicity I is 2, orthogonal carrier M is 4;

FIG. 15: The Cross-correlation function graph of Group Perfect Complete Complementary Orthogonal Code Pairs MateB 1, 15 and B2,15 after shifting;

FIG. 16: The Cross-correlation function graph of Group Perfect Complete Complementary Orthogonal Code Pairs Mate B1, 25 and B2,25 after shifting;

FIG. 17: The Cross-correlation function graph of Group Perfect Complete Complementary Orthogonal Code Pairs Mate B1,35 and B2,35 after shifting;

FIG. 18: The Cross-correlation function graph of Group Perfect Complete Complementary Orthogonal Code Pairs Mate B1,18 and B2,18 after shifting;

FIG. 19: The logic structure of tap delay of Overlapped Code Division Multiplexing system when the overlapping multiplicity I is 2;

FIG. 20: The logic structure of refined tap delay of Overlapped Code Division Multiplexing system when the overlapping multiplicity I is 2;

FIG. 21: The logic structure of tap delay line of Overlapped Code Division Multiplexing system when the overlapping multiplicity I is N.

Like reference numerals refer to like parts throughout the several views of the drawings.

### DESCRIPTION OF THE PREFERRED EMBODIMENT

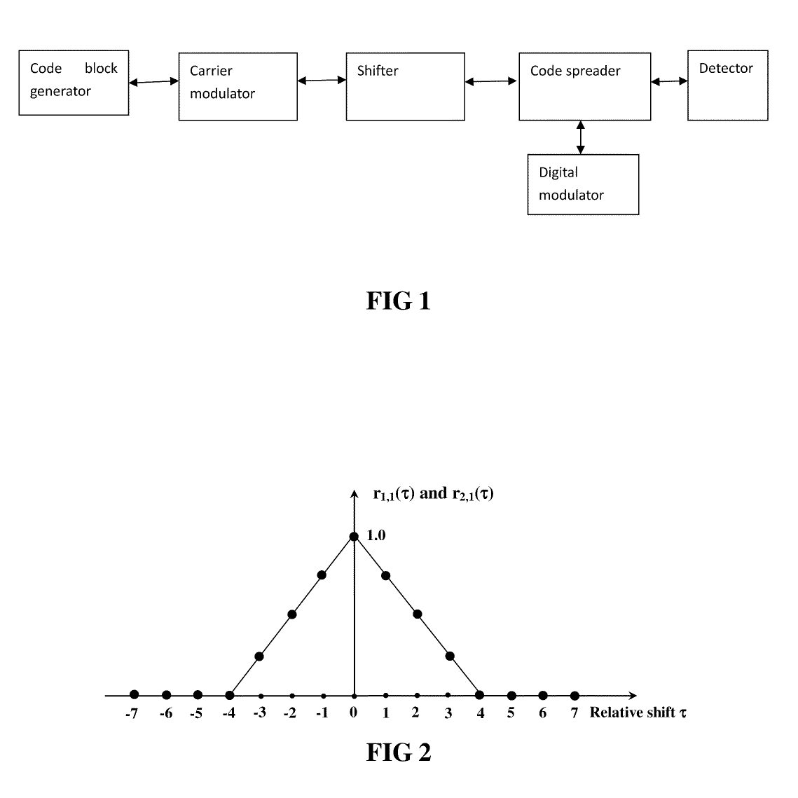

We discuss the present invention to the specific implementation with the combination of the following graphs. As shown in FIG. 1, the present invention provides a code division multiplexing system which includes the following functional modules: a group code generator for constructing Basic Group Perfect Complete Complementary Orthogonal Code Pairs Mate; a carrier modulator for modulating the C code and S code of Basic Group Perfect Complete Complementary Orthogonal Code Pairs Mate to M orthogonal carriers or M orthogonal polarization waves, where the paires mate are consecutively ordered in time; a shifter for continuous shifting of the modulated Basic Group Perfect Complete Complementary Orthogonal Code Pairs Mate. If it needs to generate more code groups, the system may also include code expander which is used to expand the number and length of the code rooted form Basic GroupPerfect Complete Complementary Orthogonal Code Pairs Mate after modulation and shifting; the system also includes a data modulator which is used to load the information to the called shifted or expanded Basic GroupPerfect Complete Complementary Orthogonal Code Pairs Mate. The receiver system includes a detector which is used for multi-code joint detection of the information loaded on Basic GroupPerfect Complete Complementary Orthogonal Code Pairs Mate.

Although in the example, we process the shift firstly and then expands the Group Basic Group Perfect Complete Complementary Orthogonal Code Pairs Mate, in practical applications, we can first expand and then shift the code as needed, and the code expander is not a required device in the present invention, which is utilized to obtain more signature sequences.

The overlapped code division multiplexing method and system in present invention improves the overlapping mutiplicity of code group to improve the spectrum efficiency of communication systems, and increases Code Efficiency until much greater than 1. The signature sequence group of Overlapped Code Division Multiplexing system will maintain a “zero correlation window” in the beginning, but with the increase of overlapping multiplicity, the “zero correlation window” will be gradually narrowed. If Code Efficiency reaches to a specific value of NA (NA>1), the signature sequence group will lose the “zero correlation window” but will remain orthogonal. At this point, the system capacity and spectral efficiency achieve the maximum value. Of course, the increase in system capacity and spectral efficiency is bound to the cost of the complexity of signal processing and increase of Threshold SIR.

The signature sequence group of the overlapped code division multiplexing method and system remains of the present invention “zero correlation window” feature, but a prerequisite is that the “zero correlation window” width of signature sequence group must at least twice the channel maximum time-proliferation Δ. As well known LAS-CDMA and DBL-CDMA are signature sequences of “zero correlation window”, but the latter, as a result of using fixed or random Expansion Matrix replacing the elements of signature sequence, it not only substantially increase the number of available code words but also substantially broadens the “zero correlation window” width of signature sequence group cross-correlation function. Since the “zero correlation window” width of the DBL-CDMA system can be broadened, it is possible that the width will not be narrow than a multiplier of channel maximum time-proliferation according to the requirements of system design which provide a necessary demand for the overlapped code division multiplexing.

DBL-CDMA Grouped Perfect Complementary Orthogonal Code Pairs Mate is as follows:

Bⱼ=Cⱼ[+]Sⱼ, j=1,2;

Where, Bⱼ(j=1,2) is a Basic Group Perfect Complete Complementary Orthogonal Code Pairs Mate, Symbol [+] denotes complementary sum which is defined as: when computing in or between code group Bⱼ(j=1,2), the C part and S part is calculated separately, and there is no mutual operation between them, except adding the results together;

For example, the shortest and the most simple Basic Group Perfect Complete Complementary Orthogonal Code Pairs Mate with code length N=2NA (the code length of Group Perfect Complete Complementary Orthogonal Code Pairs Mate as a unit in NA), Cⱼ,Sⱼ(j=1,2) are as follows:

C₁ code group: A,A;S₁ code group: A,Ā

C₂ code group: Ā,A;S₂ code group: Ā,Ā, Ā is K×N_{A} order Expansion Matrix (N=2N_{A} is even; K is positive integer), Ā is negative of A (Ā=−A), and A can be fixed element constant matrix, or random elements of random matrix.

The form of a K-vector:

$$A = [ \begin{matrix}{a}_{0}^{T} \\ {a}_{1}^{T} \\ ⋮ \\ {a}_{K - 1}^{T}\end{matrix} ] , {a}_{k}^{T} = [ \begin{matrix}{a}_{k , 0} & {a}_{k , 1} & {a}_{k , 2} & … & {a}_{k , {N}_{A} - 1}\end{matrix} ] ;$$

$$k = 0 , 1 , … , K - 1 ,$$

The column form of NA-vector:

A=[\vec{α}₀ \vec{α}₁ . . . \vec{α}_{N}_{_{A}}₋₁];

\vec{α}_{k′}=[α_{0,k′} α_{1,k′} . . . α_{K-1,k′]}_{T};

k′=0,1, . . . , N_{A}−1,

The basic C code and S code of Group Perfect Complete Complementary Orthogonal Code Pairs Mate have code length N=2NA, which means each code has N=2NA Chips; B₁,B₂ each has K complementary codes.

It can be easily proved from the complementary sense that for any Expansion Matrix A, the Non-cyclic Cross Correlation Function of any pair of code between B1 and B2 groups is entirely optimal (cross-correlation is zero everywhere), as commonly known that there is no secondary peak. This is the Group Perfect Complete Complementary Orthogonal Code Pairs Mate.

However, from the complementary sense, no matter B₁=C₁[+]S₁ or B₂=C₂[+]S₂, the Non-cyclic auto-correlation function and cross-correlation function of the K codes are not ideal when relative shift is less than the number of rows NA of A (the existence of Secondary peak). When relative shift is equal to or greater than NA, the Secondary peak of auto-correlation and cross-correlation function is always zero, whose correlation characteristics are completely determined by the corresponding row vector correlation characteristics or correlation characteristics between row vectors of matrix A when the relative shift is less than NA. However, the cross-correlation function of the code among the two groups is absolutely ideal to any matrix A.

Please see the following example of a more specific case (NA=4, N=8, K=4):

$$Suppose A = [ \begin{matrix}+ & + & + & + \\ + & - & + & - \\ + & + & - & - \\ + & - & - & +\end{matrix} ] ;$$

The first group code B1 is: B₁=C₁[+]S₁

$$\begin{matrix}Which \text{:} C 1 = [ \begin{matrix}{C}_{1 , 1} \\ {C}_{1 , 2} \\ {C}_{1 , 3} \\ {C}_{1 , 4}\end{matrix} ] = \{ \begin{matrix}+ & + & + & + & + & + & + & + \\ + & - & + & - & + & - & + & - \\ + & + & - & - & + & + & - & - \\ + & - & - & + & + & - & - & + ;\end{matrix} \\ {S}_{1} = [ \begin{matrix}{S}_{1 , 1} \\ {S}_{1 , 2} \\ {S}_{1 , 3} \\ {S}_{1 , 4}\end{matrix} ] = \{ \begin{matrix}+ & + & + & + & - & - & - & - \\ + & - & + & - & - & + & - & + \\ + & + & - & - & - & - & + & + \\ + & - & - & + & - & + & + & - ;\end{matrix}\end{matrix}$$

The second group code B2 is: B₂=C₂[+]S₂

$$\begin{matrix}Which \text{:} {C}_{2} = [ \begin{matrix}{C}_{2 , 1} \\ {C}_{2 , 2} \\ {C}_{2 , 3} \\ {C}_{2 , 4}\end{matrix} ] = \{ \begin{matrix}- & - & - & - & + & + & + & + \\ - & + & - & + & + & - & + & - \\ - & - & + & + & + & + & - & - \\ - & + & + & - & + & - & - & + ;\end{matrix} \\ {S}_{2} = [ \begin{matrix}{S}_{2 , 1} \\ {S}_{2 , 2} \\ {S}_{2 , 3} \\ {S}_{2 , 4}\end{matrix} ] = \{ \begin{matrix}- & - & - & - & - & - & - & - \\ - & + & - & + & - & + & - & + \\ - & - & + & + & - & - & + & + \\ - & + & + & - & - & + & + & - ;\end{matrix}\end{matrix}$$

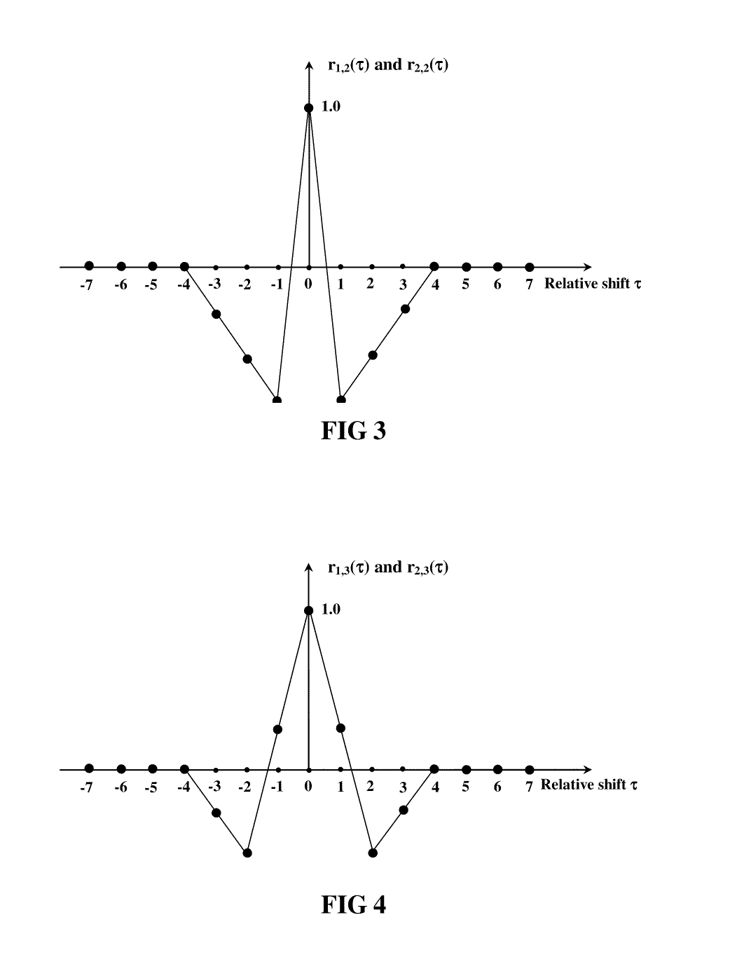

The basic code length N=8, NA=4, each code has K=4 complementary code, and the two groups have a total of eight pairs of complementary code, and the Code Efficiency is ½. The corresponding code word sequence auto-correlation function of B1 and B2 r_{j,k}(τ)(j=1,2,k=1, 2, 3, 4, τ=0±1,±2, . . . , ±7) are the same, and the specific auto-correlation function is shown in FIG. 2 to FIG. 5.

It can be seen, whether the relative shift τ of code auto-correlation function of B1 or B2 is less than NA=4, namely τ=0, ±1, ±2, ±3, it will be exactly the same as correlation function of the corresponding row vector of expansion matrix A. But when the relative shift τ is bigger than NA=4, i.e. τ=±4, ±5, ±6, ±7, they are all equal to 0.

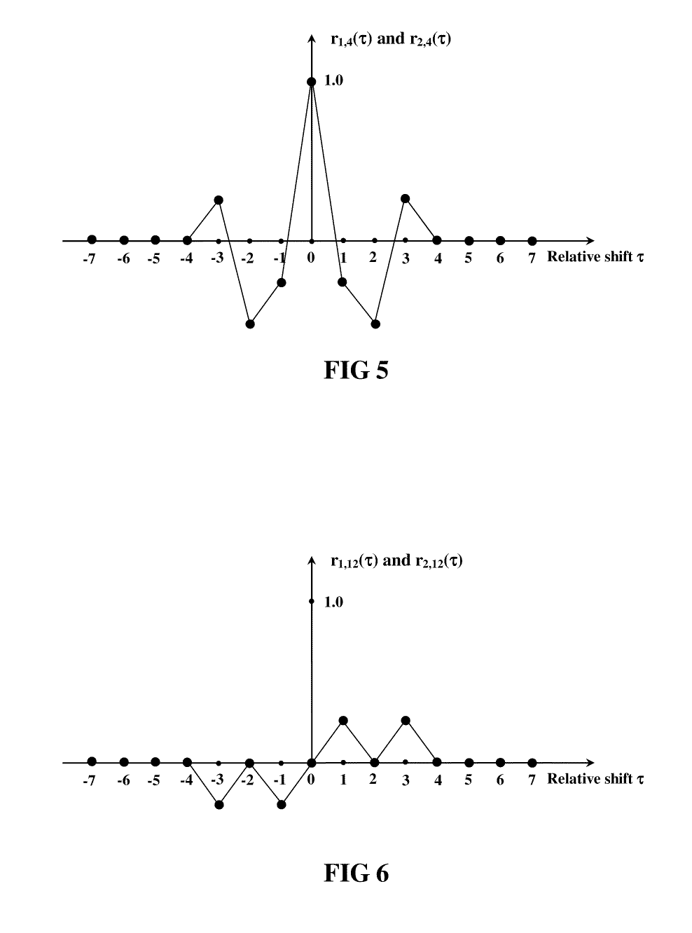

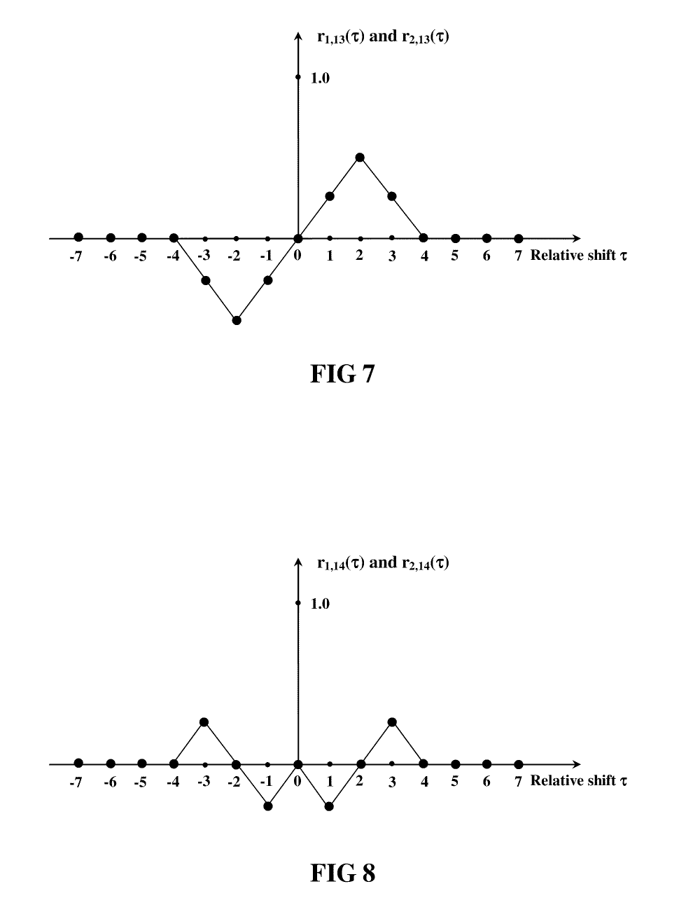

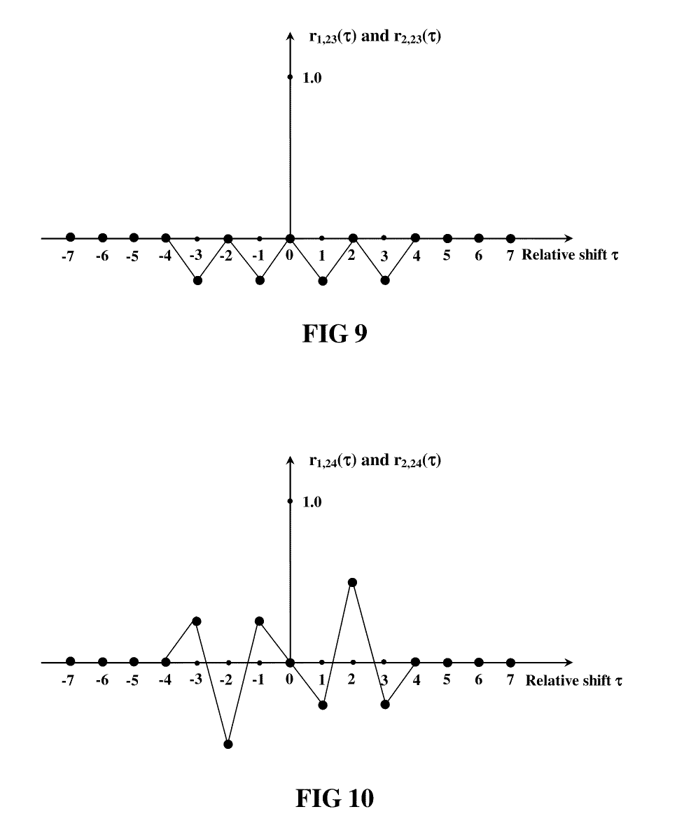

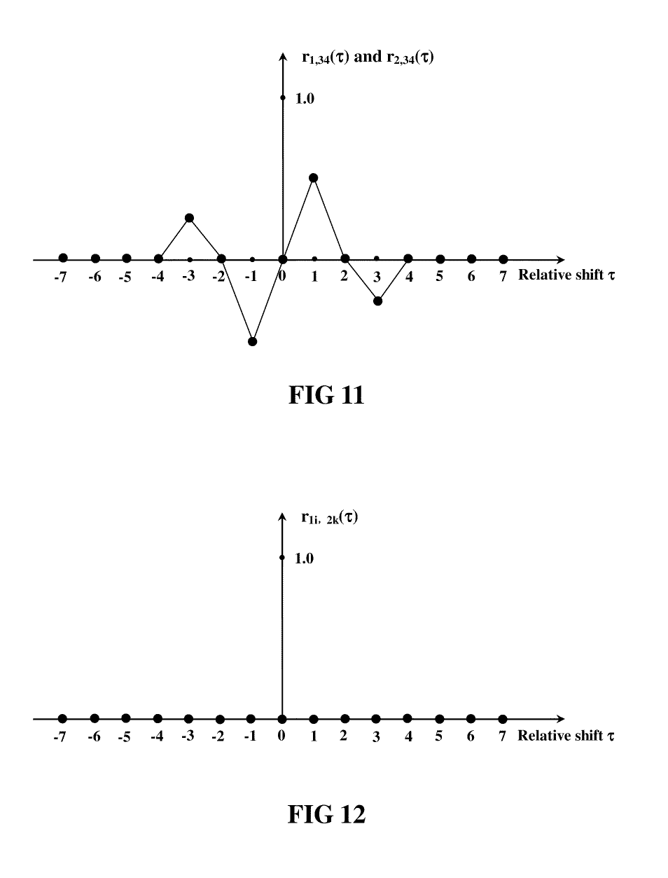

Regardless of B1 or B2, the cross-correlation function r_{j,kl}(τ)(j=1, 2,k,l=1, 2,3,4,τ=0,±1,±2, . . . , ±7) between code of corresponding code sequence are completely the same, and the specific cross-correlation function within the group is shown in FIG. 6 to FIG. 11.

It can be seen, whether the relative shift τ of code cross-correlation function of B1 or B2 is less than NA=4, namely τ=0, ±1 ,±2, ±3, it will exactly the same as cross-correlation function of the corresponding row vector of expansion matrix A. But when the relative shift τ is bigger than NA=4, i.e. τ=±4,±5,±6,±7, they are all equal to 0.

Any pair of code between B1 and B2, such as cross-correlation function r_{1k,2l}(τ) (k,l=1,2,3,4; τ=0, ±1, ±2, . . . , ±7) of B₁ₖ and B₂ₗ(k,l=1 ,2, . . . 4), is perfect to any relative shift (that is r_{1k,2l}(τ)≡0,∀k,l=0, ±1, ±2, . . . , ±7) as shown in FIG. 12 which is the group code cross-correlation function.

It can be seen that the cross-correlation feature between group code is completely perfect, and the auto-correlation and cross-correlation of group code is not perfect when relative shift is less than NA (τ<N_{A}). But when relative shift is bigger than NA (τ≧N_{A}), it will be the contrary result. Clearly, when address users are distributed by the code group, and group code is only assigned to the same address user, the fatal “near-far effect” problem is absolutely impossible to happen. We can check that the above-mentioned characteristics is correct to Grouped Multiple Access Codes with “Zero Correlation Window” of any K×N_{A} order expansion matrix A (the basic code length is NA multiples).

Suppose the chip width is T_{C}, then the basic code time width is NT_{C},there is k pair of complementary code among B₁=C₁[+]S₁ and B₂=C₂[+]S₂. There are no multi-frequency elements for expanding bandwidth factor in expansion matrix A, and when it is an orthogonal matrix (that is, the group code word orthogonal), according to Welch bound, it only has K=NA. At this point group code B₁=C₁ [+]S₁ and B₂=C₂ [+] S₂ have up to NA code words, and the total number of code word is N, the code efficiency is ½. It can be very easy to check that whether B₁=C₁ [+]S₁ or B₂=C₂ [+]S₂, the code group auto-correlation or cross-correlation function characteristics are not ideal when relative shift is less than NA (τ<N_{A}), and its feature is completely determined by the design of matrix A. Although when matrix A is orthogonal it can ensure code group be orthogonal, but according to Welch bound, the auto-correlation or cross-correlation function of code group are not ideal when |τ|<N_{A}, but it is contrary when |τ|<N_{A}. The most important is that the cross-correlation function of code between group is absolutely ideal to any expansion matrix A, which is the key to ensure that the system does not have fatal “Near Far Effect”, and it is also the feature of DBL-CDMA signature sequence. As for the non-ideal correlation function of code group, it can be completely resolved by Multi-codes Joint Detection (commonly known as multi-user detection) in receiving. Since the group code is given to the same user and is fully synchronized, and its propagation characteristics of channel are exactly the same, group code number is completely fixed, which bring tremendous convenience to the implementation of multi-code joint detection. Of course, correlation between code group can Threshold SIR of multi-code joint detection losing correlation. That is to say, without the need for the implementation of multi-code joint detection, it is necessary to increase it, but as long as the loss of Threshold SIR and complexity of multi-code joint detection can practically tolerate, you can maximally increase the number of code group, and there is no need to maintain matrix A orthogonal. Only when A is an orthogonal matrix, it will bring convenience to signal processing.

Obviously, the unilateral “zero correlation window” width of the generated DBL-CDMA signature sequence will be N−1 when taking Group Perfect Complete Complementary Orthogonal Code Pairs Mate as “Root” or “Kernel”. If (N−2)T_{C}≧2Δ (Δ is the maximum channel time proliferation), then in the synchronous conditions, we can use Code Pairs Mate of shift NC=NA=N/2 at the same time in order to double the practical system available signature sequence words. After appropriate arrangements the system capacity will also be doubled. Similarly, if (N−l)T_{C}≧lΔ, (l=1, 2, 3, . . . ), with the means of shifting code group N_{C}=N/l, we can make practical system with the available signature sequence words and capacity increased by l times while at the same time, significantly improve the spectrum efficiency.

The present invention first discusses the simplest situation with l=2, and thus the composition of simple overlapped code-division multiplexing system. Please refer to the previous specific examples again for simplicity:

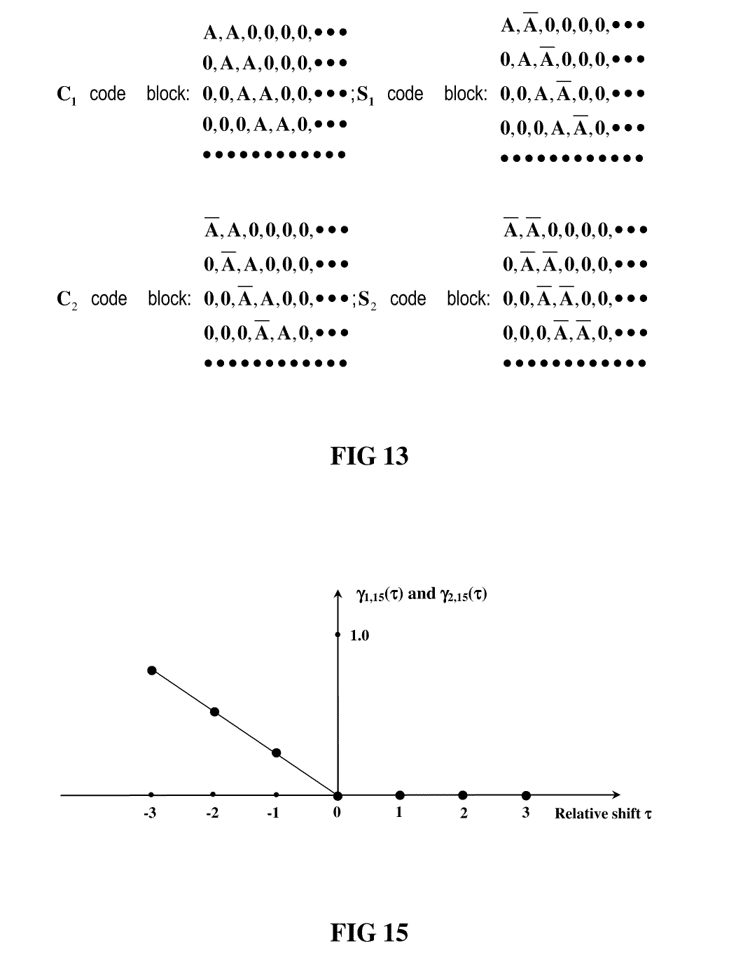

The length of basic C, S code is N=2NA, and the order of Expansion Matrix A is K×N_{A}, and the shifted chip is NC=NA, namely, the overlapping mutiplicity l=2, which will be two group shift Basic Group Perfect Complete Complementary Orthogonal Code Pairs Mate B₁=C₁ [+]S₁, B₂=C₂ [+]S₂, as shown in FIG. 13.

In order to increase system capacity, 0 elements in matrix of FIG. 13 can be filled DBL Basic Group Perfect Complete Complementary Orthogonal Code Pairs Mate which was modulated on A orthogonal carrier frequency (or carrier group). The more the number of Orthogonal carrier frequency (or carrier group) filled M1 is, the higher the system capacity is.

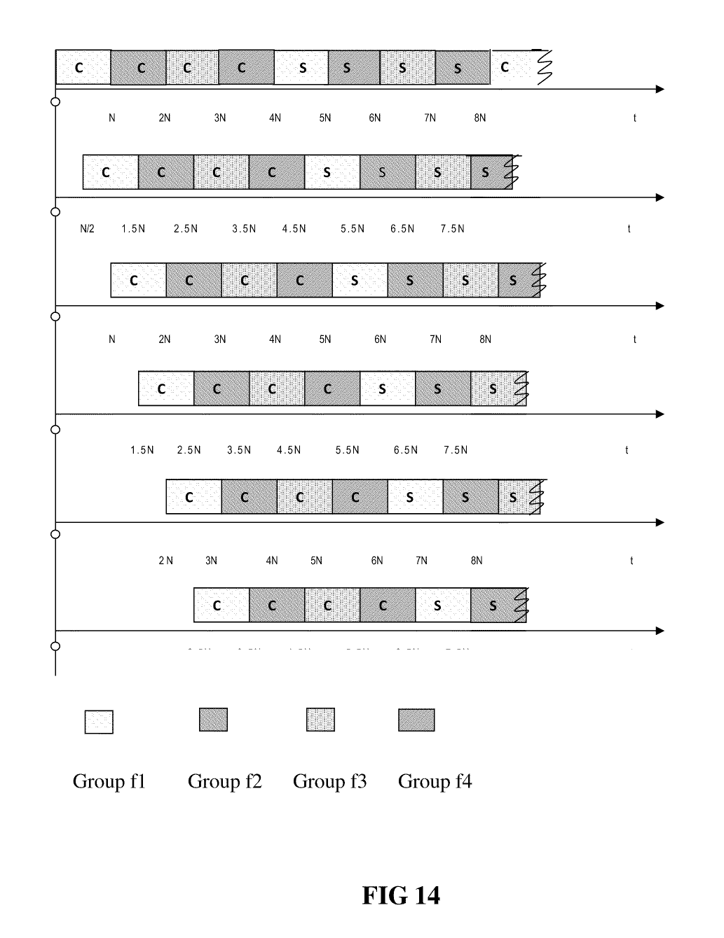

The time sequence orthogonal carrier frequency is as follows: f₁, f₂, f₃, . . . , f_{M}_{₁}, where fₖ⊥f_{k′}, ∀K≠k′, fₖ, f_{k′}, respectively denoting group k,k′(k,k′=1, 2, . . . , M₁) Orthogonal carrier frequency (or carrier group), I refers that orthogonality. Such an arrangement is to ensure that any orthogonal carrier frequency modulated Group Perfect Complete Complementary Orthogonal Code Pairs Mate by utilizing “0” filled with orthogonal carrier frequency (or carrier group) during Continuous Shift. Indeed in the computation, it can be used as a 0 matrix. Meanwhile, time sequence of M1 orthogonal carrier frequency (or carrier group) can be arranged arbitrarily. FIG. 14 is one such arrangement, where C sequence and S sequence are under time division arrangement. Since the C sequence and S sequence apart from M1NTC each other without shift, the maximum shift times can only be l (M₁−1). When l=2, it was 2(M1−1). Otherwise, C and S code group will meet each other. As can be seen in the synchronous conditions, the interval between C and S of signature sequence of the same carrier frequency (or carrier group) is

$${N}_{C} {T}_{C} = \frac{N {T}_{C}}{l} \geq Δ .$$

Of course, C and S will neither meet in the transmitter, nor in the Receiver when in the synchronous situation, but in order to ensure the complementary characteristics of C and S, C and S must have the same channel fading characteristics in the system design and keep a distance of M1NTC in time between C and S, which means that the channel coherence time must be much larger than M1NTC. Of course, C and S can also have other arrangements, for example, can be modulated separetly on orthogonal polarized waves which have the same fading characteristics.

After Continuous Shift N_{C}=N/l as shown in FIG. 13, 14 resulting in two group code, we can easily prove that from the complementary sense: for these two group code, in different large group among the various codes from different group, these cross-correlation features are still perfect everywhere (no Secondary peak). But, codes in the group, its auto-correlation and cross-correlation feature are not perfect. However, when relative shift was limited to within ±N_{C}=±N/l (rather than ±N), its auto-correlation and cross-correlation feature is only determined by correlation feature of corresponding row vector of expantion matrix or correlation feature between them, and its secondary peak will be no more than that of non-shift basic code group. We must point out that when A is orthogonal matrix, codes of all group are orthogonal. In order to make the issue more clear, take l=2, N=2N, N_{C}=N_{A}=4,

$$A = [ \begin{matrix}+ & + & + & + \\ + & - & + & - \\ + & + & - & - \\ + & - & - & +\end{matrix} ] ,$$

as an example to test the accuracy of the above conclusions, then after N_{C}=N/l=8/2=4 chip of relative shift, we can achieve the follow two code group:

$${B}_{1} = {C}_{1} [ + ] {S}_{1} , \\ C 1 code group \text{:} \begin{matrix}+ & + & + & + & + & + & + & + & 0 & 0 & 0 & 0 & 0 & 0 & 0 & 0 \\ + & - & + & - & + & - & + & - & 0 & 0 & 0 & 0 & 0 & 0 & 0 & 0 \\ + & + & - & - & + & + & - & - & 0 & 0 & 0 & 0 & 0 & 0 & 0 & 0 \\ + & - & - & + & + & - & - & + & 0 & 0 & 0 & 0 & 0 & 0 & 0 & 0\end{matrix}$$

$$\begin{matrix}0 & 0 & 0 & 0 & + & + & + & + & + & + & + & + & 0 & 0 & 0 & 0 \\ 0 & 0 & 0 & 0 & + & - & + & - & + & - & + & - & 0 & 0 & 0 & 0 \\ 0 & 0 & 0 & 0 & + & + & - & - & + & + & - & - & 0 & 0 & 0 & 0 \\ 0 & 0 & 0 & 0 & + & - & - & + & + & - & - & + & 0 & 0 & 0 & 0\end{matrix}$$

$$S 1 code group \text{:} \begin{matrix}+ & + & + & + & - & - & - & - & 0 & 0 & 0 & 0 & 0 & 0 & 0 & 0 \\ + & - & + & - & - & + & - & + & 0 & 0 & 0 & 0 & 0 & 0 & 0 & 0 \\ + & + & - & - & - & - & + & + & 0 & 0 & 0 & 0 & 0 & 0 & 0 & 0 \\ + & - & - & + & - & + & + & - & 0 & 0 & 0 & 0 & 0 & 0 & 0 & 0\end{matrix}$$

$$\begin{matrix}0 & 0 & 0 & 0 & + & + & + & + & - & - & - & - & 0 & 0 & 0 & 0 \\ 0 & 0 & 0 & 0 & + & - & + & - & - & + & - & + & 0 & 0 & 0 & 0 \\ 0 & 0 & 0 & 0 & + & + & - & - & - & - & + & + & 0 & 0 & 0 & 0 \\ 0 & 0 & 0 & 0 & + & - & - & + & - & + & + & - & 0 & 0 & 0 & 0\end{matrix}$$

$${B}_{2} = {C}_{2} [ + ] {S}_{2}$$

$$C 2 code group \text{:} \begin{matrix}- & - & - & - & + & + & + & + & 0 & 0 & 0 & 0 & 0 & 0 & 0 & 0 \\ - & + & - & + & + & - & + & - & 0 & 0 & 0 & 0 & 0 & 0 & 0 & 0 \\ - & - & + & + & + & + & - & - & 0 & 0 & 0 & 0 & 0 & 0 & 0 & 0 \\ - & + & + & - & + & - & - & + & 0 & 0 & 0 & 0 & 0 & 0 & 0 & 0\end{matrix}$$

$$\begin{matrix}0 & 0 & 0 & 0 & - & - & - & - & + & + & + & + & 0 & 0 & 0 & 0 \\ 0 & 0 & 0 & 0 & - & + & - & + & + & - & + & - & 0 & 0 & 0 & 0 \\ 0 & 0 & 0 & 0 & - & - & + & + & + & + & - & - & 0 & 0 & 0 & 0 \\ 0 & 0 & 0 & 0 & - & + & + & - & + & - & - & + & 0 & 0 & 0 & 0\end{matrix}$$

$$S 2 code group \text{:} \begin{matrix}- & - & - & - & - & - & - & - & 0 & 0 & 0 & 0 & 0 & 0 & 0 & 0 \\ - & + & - & + & - & + & - & + & 0 & 0 & 0 & 0 & 0 & 0 & 0 & 0 \\ - & - & + & + & - & - & + & + & 0 & 0 & 0 & 0 & 0 & 0 & 0 & 0 \\ - & + & + & - & - & + & + & - & 0 & 0 & 0 & 0 & 0 & 0 & 0 & 0\end{matrix}$$

$$\begin{matrix}0 & 0 & 0 & 0 & - & - & - & - & - & - & - & - & 0 & 0 & 0 & 0 \\ 0 & 0 & 0 & 0 & - & + & - & + & - & + & - & + & 0 & 0 & 0 & 0 \\ 0 & 0 & 0 & 0 & - & - & + & + & - & - & + & + & 0 & 0 & 0 & 0 \\ 0 & 0 & 0 & 0 & - & + & + & - & - & + & + & - & 0 & 0 & 0 & 0\end{matrix}$$

$$Let \text{:} {C}_{1} = [ \begin{matrix}{C}_{1 , 1} \\ {C}_{1 , 2} \\ {C}_{1 , 3} \\ {C}_{1 , 4} \\ {C}_{1 , 5} \\ {C}_{1 , 6} \\ {C}_{1 , 7} \\ {C}_{1 , 8} \\ ⋮\end{matrix} ] ; {S}_{1} = [ \begin{matrix}{S}_{1 , 1} \\ {S}_{1 , 2} \\ {S}_{1 , 3} \\ {S}_{1 , 4} \\ {S}_{1 , 5} \\ {S}_{1 , 6} \\ {S}_{1 , 7} \\ {S}_{1 , 8} \\ ⋮\end{matrix} ] ; {C}_{2} = [ \begin{matrix}{C}_{2 , 1} \\ {C}_{2 , 2} \\ {C}_{2 , 3} \\ {C}_{2 , 4} \\ {C}_{2 , 5} \\ {C}_{2 , 6} \\ {C}_{2 , 7} \\ {C}_{2 , 8} \\ ⋮\end{matrix} ] ; {S}_{2} = [ \begin{matrix}{S}_{2 , 1} \\ {S}_{2 , 2} \\ {S}_{2 , 3} \\ {S}_{2 , 4} \\ {S}_{2 , 5} \\ {S}_{2 , 6} \\ {S}_{2 , 7} \\ {S}_{2 , 8} \\ ⋮\end{matrix} ] ;$$

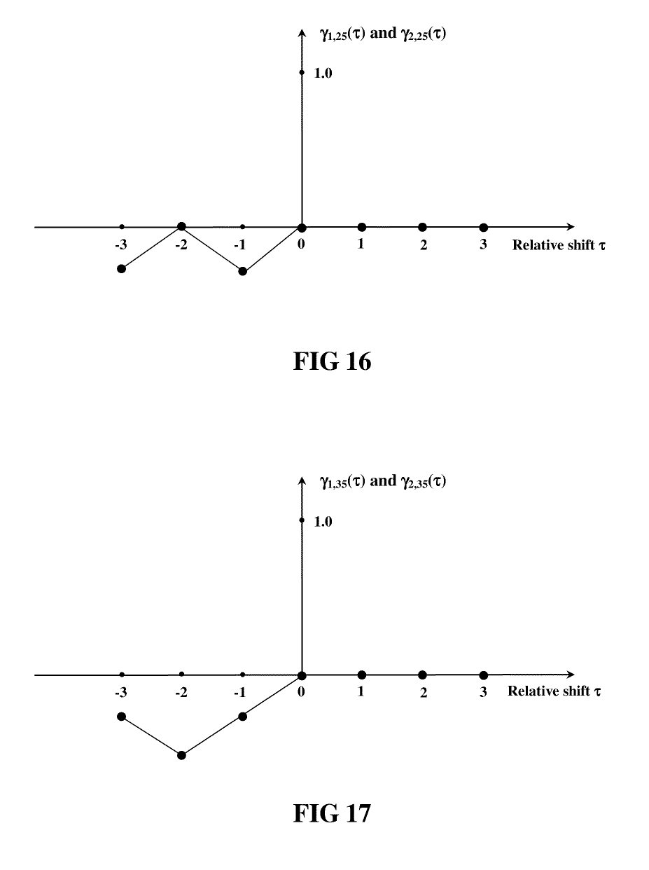

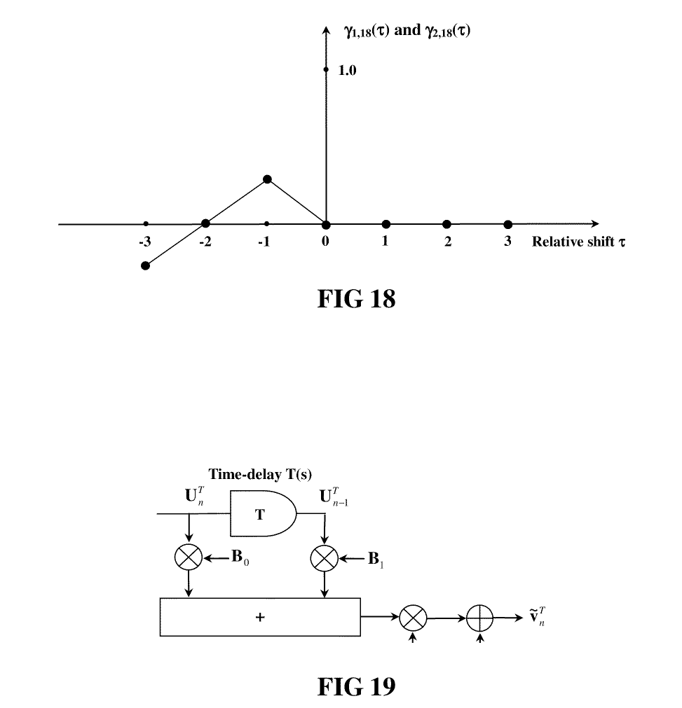

It is clear that, after shift arrangements, code in all groups, and the auto-correlation of each code remain the same as unshifted. Relative shift r should be limited within ±N_{A}=±N/2=±4,although when relative shift τ is between ±N_{A} and ±N (code length), especially when τ=±N_{A} (at this time, shift code group meet with unshift code group), it may be the bad case but there is no need to research any more. In the case of relative shift τ is beyond ±N, it is also not necessary to research again because they are certainly 0. To illustrate the subject, let us test the cross-correlation function between couple of words from code group B1 and B2 when relative shift is within ±NA, namely, the case of −4<τ<4 (see FIG. 15-FIG. 18).

As a result of combination of circumstances, there is no need to test them one by one. In short, for any l, the cross-correlation feature of any pair of code between group is ideal, but inside the group, the auto-correlation and cross-correlation feature of different code or between them are the same as the correlation feature of corresponding row vector or correlation feature between them when relative shift is less than NA. In particular, it should be noted that, for the two shift code group, the width of “zero correlation window” of cross-correlation function for any pair of code between the two group is indeed very wide, and it will cover all positive and negative shift group code length. However, because the relative shift of code group has limited to ±N_{C}, if relative shift in excess of ±N_{C},it has access to another Shift code group, so the unilateral “zero correlation window”) width of shift code group can only be NC−1 in application. This is why the “zero correlation window” width narrowing after code group shift stacking.

As we all know that the unsatisfactorily cross-correlation feature between address code is the root of the fatal “near far effect” of traditional CDMA systems. The use of the perfect cross-correlation feature between code group of DBL-CDMA or overlapped DBL-CDMA, can create no “near far effect” CDMA system. This overlapped code division multiplexing method and system of the present invention with the use of orthogonal multi-carrier frequency (or carrier group) DBL-CDMA code group overlapping, greatly enhance the system's code efficiency and spectrum efficiency. Regarding the number of signature sequence group, we can use the “spanning tree” method described in the invertor's previous patent PCT/CN2006/000947, or referred to the expansion orthogonal Hadamard matrix by using Perfect Complete Complementary Orthogonal Code Pairs Mate as “root” or “kernel” to generate a greater number of signature sequence with “zero correlation window” feature. Of course, we can also use the orthogonal multi-carrier frequency (or carrier group) Group Perfect Complete Complementary Orthogonal Code Pairs Mate of the present invention, and the direct use of time division, frequency division or orthogonal time-frequency division can generate more multiple signature sequence with the “zero correlation window” characteristics.

Now we take the following detailed examples to illustrate the structure and principle of the overlapped code division multiplexing system of the present invention. We still take the most simple example N=2NA and NC=NA to illustrate the problem for simplicity. Suppose: (Cₖ(t) Sₖ(t)) is the waveform of Basic Group Perfect Complete Complementary Orthogonal Code Pairs Mate with {Cₖ Sₖ}(k=1,2) in practical system, A(t) is the waveform of expantion matrix in practical system.

$$A ( t ) = [ \begin{matrix}{a}_{0} ( t ) \\ {a}_{1} ( t ) \\ ⋮ \\ {a}_{K - 1}\end{matrix} ] , \\ where \text{:} {a}_{k} ( t ) = {\sum }_{i = 0}^{N / 2 - 1} {a}_{k , i} {g}_{{T}_{c}} ( t - {iT}_{C} ) , k = 0 , 1 , … , K - 1 , \\ {g}_{{T}_{C}} ( t ) = u ( t ) - u ( t - {T}_{C} ) = [ \begin{matrix}1 & t ∈ ( 0 , {T}_{C} ) \\ 1 & t ∉ ( 0 , {T}_{C} ) ,\end{matrix}$$

u(t) is unit step function.

g_{T}_{_{C}}(t) is chip shaping function, In real project with limited bandwidth, it generally can not be the above rectangular waveform but waveform after roll-off filter. For the orthogonal multi-carrier case of the present invention, when the carrier number M₁ 1, it should be very close to the above defined rectangular waveform.

The Basic Group Perfect Complete Complementary Orthogonal Code Pairs Mate waveforms are:

C₁(t)=A(t)+A(t−NT_{C}/2), S₁(t)=A(t)−A(t−NT_{C}/2),

C₂(t)=−A(t)+A(t−NT_{C}/2), S₂(t)=−A(t)−A(t−NT_{C}/2),

In the practical system design, we should ensure that C(t) and S(t) have the same channel propagation conditions, C(t) will not meet S(t), and has no Cross-operator, namely C(t) only operate with C(t), S(t) only operates with S(t), and sum the operation result. After continuing T=NT_{C}/2 in time, which is half code length 2(M1−1) times Superposition of continuous shift, we can obtain two big code groups. Because codes between the two groups have a perfect cross-correlation properties, when receiving one of the two, the another has no interference on it, code group modulated on orthogonal carrier frequency (or carrier group) has no interference too. Therefore, in the following analysis, we can only consider the transmission of any code group of the two.

Suppose: B(t)=C(t)[+]S(t), t∈(0,NT_{C}] is any one code any one group code to be transmitted, and

B(t)=0, t∉(0, NT_{C})

Completely with the former, where symbol [+] means complementary add, tnamely, C(t) and S(t) “simultaneity” (referring to the same transmission characteristics) transmit and sum the Operational results. Computing respectively C(t) and S(t),and do not allow cross-operator between C(t) and S(t).

Assume code energy of

$$B ( t ) = C ( t ) [ + ] S ( t ) = [ \begin{matrix}{b}_{0} ( t ) \\ {b}_{1} ( t ) \\ ⋮ \\ {b}_{K - 1} ( t )\end{matrix} ]$$

is unitary, that is:

$${\int }_{0}^{{NT}_{C}} {‖ {b}_{k} ( t ) ‖}^{2} d t = {\int }_{0}^{{NT}_{C}} ( {‖ {C}_{k} ( t ) ‖}^{2} + {‖ {S}_{k} ( t ) ‖}^{2} ) d t = 1 , \\ k = 0 , 1 , … , K - 1 ,$$

And assume that all code load information is independently in transmission, then emission signal complex envelope can be expressed as:

$$\sqrt{2 E} {\sum }_{n} {U}_{n}^{T} B ( t - nT ) , n = 0 , 1 , 2 , …$$

### Where:

T=NT_{C}/2, is half the basic code length;
B(t)=0, t(0, 2T];
E is power of emission symbol;
Uₙ=[ũ_{0,n} ũ_{1,n} . . . ũ_{K-1,n}]^{T},
ũ^{k,n}=I_{k,n}+jQ_{k,n},(k=0, 1, . . . , K−1) is complex data symbols transmitted by code k(k=0, 1, . . . , K−1) of the code group when t∉(nT,(n+1)I].

In the practical computation time of the code group, I channel was in flat fading in the time domain, otherwise the complementary characteristics of DBL-CDMA signature sequence is difficult to guarantee. For simplicity, we only study T_{C} A, where the channel time-proliferation can be ignored, channel was flat fading in the frequency domain and the problem becomes very simple, especially because the matrix A is orthogonal matrix, and all the codes are all orthogonal regardless of in or between the code group. As we all know that the treatment of orthogonal codes is very simple, because T has only half of the code length, so the system is a typical time overlapped multiplexing with its overlapping mutiplicity l=2. Please note that the present invention is aimed at the general (N−1)T_{C}/2≧Δ situation. Of course we include Δ>T_{C} and even the case of Δ T_{C}, which is the case when channel shows frequency selective fading. At this time, complexity of multi-code joint detection in the receiver as well as complexity of the theory in particular error probability performance analysis will be increased more than the case of flat fading. There is no real difference between them, and therefore in the present invention, we will no longer introduce such a relatively complex situation.

The received signal complex envelope is:

$$V ( t ) = \frac{1}{2} \sqrt{2 {E}_{S}} {\sum }_{n} {U}_{n}^{T} B ( t - nT ) + \tilde{n} ( t ) , n = 0 , 1 , …$$

Where:

B(t)=0, t∉(0, 2T];

E_{S} is Received symbol energy;

ñ(t) is complex envelope of Complex white Gaussian noise, its power spectral density is N₀,

$$Let \text{:} S ( t ) = {\sum }_{n} {U}_{n}^{T} B ( t - nT ) ,$$

Then when t∈E (nT,(n+1)T], The transmission period of n time slots symbol, the received signal complex envelope is:

$${V}_{n} ( t ) = \frac{1}{2} \sqrt{2 {E}_{S}} {S}_{n} ( t ) + {\tilde{n}}_{n} ( t ) ,$$

Where:

$${S}_{n} ( t ) = {\sum }_{i = 0}^{1} {U}_{n - i}^{T} {B}_{i} ( t - nT ) ,$$

Vₙ(t) V(t)g_{T}(t−nT),
Sₙ(t) S(t)g_{T}(t−nT),

Here: ñₙ(t) ñ(t)g_{T}(t−nT),
Bᵢ(t) B(t+iT)g_{T}(t),
g_{T}(t) u(t)−u(t−)∘

n=0,1,2 . . . .

It is clear that, the complex envelop of the received signal Sₙ(t)(n=0, 1, . . . ) is the complex convolution of transmission data sequence U=[U₀^{T},U₁^{T},U₂^{T} . . . ]^{T} and matrix sequence [B₀(t),B₁(t)]^{T}.

For (C₁,S₁) code group:

B₀(t)=A(t)[+]A(t), B₁(t)=A(t)[+]Ā(t),

For (C₂,S₂) code group: B₀(t)=Ā(t)[+]A(t),

Where, any •(t) is time waveform contain NC (in this example NC=NA=N/2) chips, for signal processing, we can use NC-dimensional vector(such as \tilde{s}ₙ(t)→\tilde{s}ₙ,\tilde{v}ₙ(t)→\tilde{v}ₙ,ñₙ(t)→ñₙ, etc) and K×N_{C} order matrix (such as B(t)→B etc) to express respectively.

As a result, the implementation of case l=2 overlapped code division multiplexing system can be described only use a “tapped delay” model with l−1=1 section shift register, as is shown in FIG. 19.

In FIG. 19, the first tap coefficient is B₀, the second tap coefficient is B₁, they are both K×N/2 order matrix. The input of channel in time slot n is Uₙ=[ũ_{0,n} ũ_{1,n} . . . \tilde{K}_{K-1,n}]^{T}. It is a K-dimensional Q elements vector, where Q is the number of data bits loaded on basic modulation symbols, noise ñₙ=[ñ_{n,0},ñ_{n,1}, . . . , ñ_{n,/2-1}]^{T}, channel output \tilde{v}ₙ=[\tilde{v}_{n,0},\tilde{v}_{n,1}, . . . , \tilde{v}_{n,N/2-1}]^{T} are both NC=N/2 order matrix.

In order to describe system model more clearly, let

$${B}_{i} = [ \begin{matrix}{b}_{0 , 0}^{i} & {b}_{0 , 1}^{i} & … & {b}_{0 , N / 2 - 1}^{i} \\ {b}_{1 , 0}^{i} & {b}_{1 , 1}^{i} & … & {b}_{1 , N / - 2 - 1}^{i} \\ ⋮ & ⋮ & … & ⋮ \\ {b}_{K - 1 , 0}^{i} & {b}_{K - 1 , 1}^{i} & … & {b}_{K - 1 , N / 2 - 1}^{i}\end{matrix} ] , i = 0 , 1 ,$$

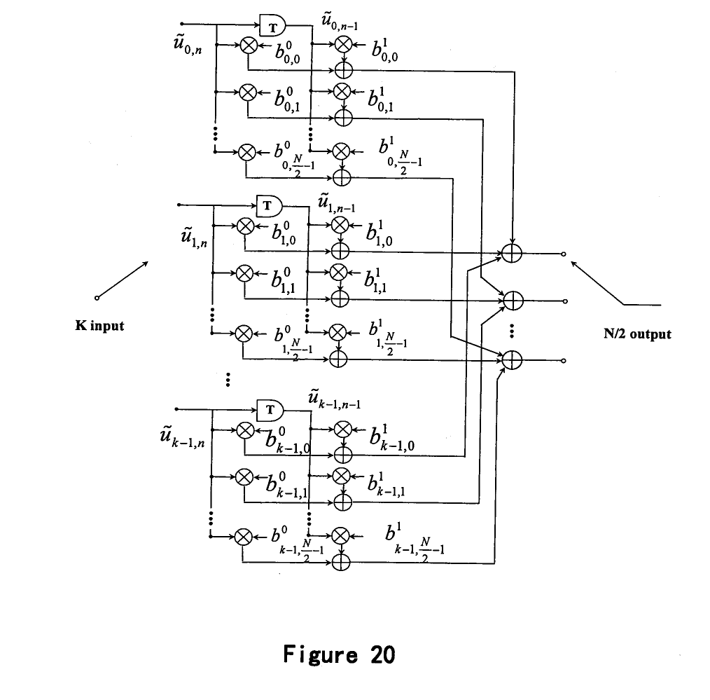

As a result, the system model “tapped delay line” part in FIG. 19 can be specifically refined into FIG. 20. It is very similar to a convolutional encoder model with code efficiendy 2K/N and constraint length 1.

Apparently, the number of steady states of l=2 multiplicity overlapped systems “tapped delay” model is Q^{K}, B mutiplicity overlapped code division systems does not have transition state, and the initial and the final state is 0. There are Q^{K} combination of input data. The system constraint length is 1, and each state can transfer to other Q^{K} states. Completely similar, the overlapped code division system model with higher than two multiplicity (l>2) will contain more shift registers. It has Q^{K(l-1)} steady states, and the initial and the final state is 0 too, but it has anterior transition state and posterior transition state. The specific state transition principle is mentioned in the other two previous patents of the present inventor with Patent No. PCT/CN2006/2012 and PCT/CN2006/001 585.

As we all know, when Channel noise is white Gaussian noise, the optimal receiver is to be the smallest Euclidean distance receiver, that is, to find the optimal data sequence U=[U₀^{T},U₁^{T},U₂^{T} . . . ]^{T}, so that Euclidean distance between sequence [\tilde{v}₀,\tilde{v}₁,•••] and sequence

$$\frac{1}{2} \sqrt{2 {E}_{S}} [ {\tilde{s}}_{0} , {\tilde{s}}_{1} , … ]$$

is the smallest. We can use Maximum Likelihood Sequential Multi-codes Joint Detection-MLSMCD algorithm to achieve this. Its algorithm complexity determines the number of state Q^{K(l-1)} of systems.

For example, when l=2, N=8, K=4, Q=4 (16QAM or 16PM modulation), the number of system “tapped delay” model state is Q^{K}=4⁴⁼²⁵⁶, input data Uₙ and Q^{K}=4⁴=256 combinations. Each state can transfer to the other 256 states. For the Specific Maximum Likelihood Sequential Multi-codes Joint Detection (MLSMCD) algorithm please refer to the other two previous patents with Patent No. PCT/CN2006/2012 and PCT/CN2006/001 585.

It needs to be emphasized that when A is an orthogonal matrix (including situation of A contains L orthogonal subcarriers) and T_{C} Δ, because the various codes in the receiver are completely orthogonal, Maximum Likelihood Sequential Multi-codes Joint Detection algorithm will degrade into the respective code-by-code detection for each code which is different from the traditional code-by-code detection. When implementing correlation detection operation for them respectively, its integration time is overlapped. This is also one reason that the present invention focuses on the low chip rate (T_{C} Δ).

In order to further improve the spectrum efficiency, code group shift superposition can take NC<NA as a unit, and its maximum spectrum efficiency should appear in the chip TC for the shift unit, namely, N_{C}=1,l=N. The following analysis describes such case:

$$Let \text{:} A = [ \begin{matrix}{\vec{α}}_{0} & {\vec{α}}_{1} & … & {\vec{α}}_{N / 2 - 1}\end{matrix} ] , \\ B = C [ + ] S = [ {b}_{0} , {b}_{1} , … , {b}_{N - 1} ] , \\ S ( t ) = {\sum }_{n} {U}_{n}^{T} B ( t - {nT}_{C} ) ,$$

Then when t∈(nT,(n+1)T], i.e. transmission period of number n chip, the received signal complex envelope is:

$${V}_{n} ( t ) = \frac{1}{2} \sqrt{2 {E}_{S}} {S}_{n} ( t ) + {\tilde{n}}_{n} ( t ) ,$$

Which:

$${S}_{n} ( t ) = {\sum }_{i = 0}^{N - 1} {U}_{n - i}^{T} {b}_{i} ( t - {nT}_{C} ) ,$$

Here:
Vₙ(t) V(t)g_{T}(t−nT_{C}),
Sₙ(t) S(t)g_{T}(t−nT_{C}),
ñₙ(t) ñ(t)g_{T}(t−nT_{C}),
bᵢ(t) b(t+iT)g_{T}(t),
g_{T} (t) u(t)−u(t−T_{C})∘

n=0, 1, 2 . . . .

It is clear that the complex envelope of the received signal Sₙ(t)(n=0, 1, . . . ) is the complex convolution of Transmission data sequence transpose U=[U₀^{T},U₁^{T},U₂^{T} . . . ]^{T} and vector sequence [b₀(t),b₁(t), . . . , b_{N-1}(t)]^{T}.

Apparently, for (C₁,S₁) code group:

bᵢ(t)=\vec{α}ᵢ(t)[+]\vec{α}ᵢ(t),i=0, 1, . . . , N/2−1,

bᵢ(t)=\vec{α}_{i=n/2}(t)[+] \overline{\vec{α}}_{i-N/2}(t),i=N/2,N/2+1, . . . , N−1,

for (C₂,S₂) code group:

bᵢ(t)= \overline{\vec{α}}_{i-N/}2(t)[+]\vec{α}ᵢ(t),i=0, 1, . . . , N/2−1,

bᵢ(t)= \overline{\vec{α}}_{i-N/}2(t)[+] \overline{\vec{α}}_{i-N/}2(t),i=N/2,N/2,N/2+1, . . . , N−1,

\overline{\vec{•}} is negative of \vec{•}.

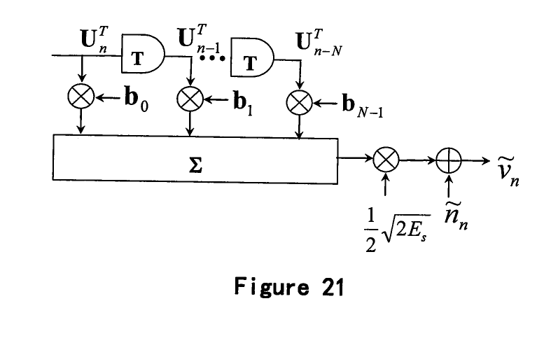

Similarly, here •(t) is waveform with only one chip, which can be scalar or vector in signal processing. As a result, N multiplicity (l=N), namely, chip level overlapped code division multiplexing system can use “tapped delay line” model of l−1=N−1 shift register of the to describe, as shown in FIG. 21.

The system model of FIG. 21 can provide the highest spectral efficiency. Here only Uₙ,bₖ are K-dimensional vectors, the other is scalar, and its refined model is neglected here.

When relative shift take NC=mNA (m is any positive integer, NA is the number of rows of expansion matrix A) as a unit, system overlapping mutiplicity l=N/mN_{A}, code efficiency is less than 1 when m>1, and it can reach 1 when m=1. System signature sequence group has a “zero correlation window” feature, and its unilateral window width is mNA−1.

When relative shift take NC<NA chips as a unit, system overlapping mutiplicity l=N/N_{C}, system signature sequence group still has a “zero correlation window” feature, and its unilateral window width is NC−1. Its code efficiency is bigger than 1, and system has higher spectrum efficiency.

When relative shift take single chip as a unit, system signature sequence group will lose the “zero correlation window” feature, but still be orthogonal. If Code efficiency reaches the highest, the system has the highest spectrum efficiency. It determines the number of column NA of expansion matrix A, and the greater NA is, the higher the maximum spectral efficiency is.

The case when shift unit Nc is greater than NA and not whole multiple of NA is not recommended here. At this time, code efficiency and system spectrum efficiency are both low, and system complexity is also high when NC/NA is non-integer. We do not recommend the case of shift unit N_{C}<1, as it will lead to the expansion of system bandwidth.

Now we take a detailed analysis of the code division multiplexing system when non-use of orthogonal frequency sub-frame (ie, M2=1,M=M1, single-cell non-network), expansion matrix A contains L frequency elements (subcarriers), and the basic code length is N, shift unit is NC chip, overlapping mutiplicity l=N/N_{C}, and the system required bandwidth B, and system total capacity is R, spectrum efficiency is η and other major technical indicators.

Where:

$$A = [ \begin{matrix}{A}_{0} cos ( 2 π {f}_{0} t + {ϕ}_{0} ) \\ {A}_{0} cos [ 2 π ( {f}_{0} + Δ f ) t + {ϕ}_{1} ] \\ ⋮ \\ {A}_{0} cos [ 2 π ( {f}_{0} + ( L - 1 ) Δ f ) t + {ϕ}_{L - 1}\end{matrix} ] ;$$

A0 is N_{A}×N_{A} matrix,

Δf=0.5 f_{C} or f_{C} (because according to the simulation and experiment, the maximum likelihood multicode joint sequential detection also can handle even Δf=0.5 f_{C} or even smaller for the LN_{A}×N_{A} matrix, but the SNR of threshold need To improve, while smaller Δf is apparently profitable To improve the efficiency of system frequency.but after Δf<0.5 f_{C} the SNR loss is obviously big, so it is not recommended to use.)

The basic parameters of the system need are as follows:

N Basic C, S code length;

K×N_{A} Expand the order of A matrix;

N_{C} Number of The relative displacement code;

l Code group overlap weight: l=N/N_{C};

M The number of groups of orthogonal carrier frequency in all sub-frame (M≧2);

L The subcarrier number of Expand matrix A, that is to make use of a group of subsidiaries with L carrier to expand the number of orthogonal matrix columns, then K=NAL;

Q Information bits that Every modulation signal (code) load, 2Q is the number of The modulated signal levels;

R Total system capacity (bps, Mbps, Kbps);

η System Spectrum efficiency (bps/Hz/cell(sector));

B System bandwidth (Hz, KHz, MHz);

fc Chip rate (cps);

Total system capacity (bps) calculation:

Since the basic C, S code length is NT_{C}, there's an orthogonal carrier frequency m. group basic carrier (When there are L carrier frequency in A matrix, it is M Orthogonal carrier group) of orthogonal code length(total code group length) of duality is 2MNT_{C}. Supposing that in every frame, the frame size is 2MNT_{C}+[M−(1+1/l)]NT_{C} M≧2, where, [M−(1+1/l]NT_{C} is the trailing length produced by Code group shifting. When the number of overlap is l=N/N_{C}, number of Maximum groups code shifting is l(M−1)=N(M−1)/N_{C}, there are 2 groups, every of which has N_{A} pairs. Total number of Carrier group is M, there still has L subcarrier in A. System of every frame can transmit 2^{N}(M−1)N_{A}LMQ/N_{C} bits, because each pair code(including shift code) in each carrier can load Q bit information. When the system frame length is longer, trailing length can be ignored, then the total capacity of system approximates is:

$$R ≅ \frac{2 N ( M - 1 ) {N}_{A} LMQ}{2 {MN}_{C} {T}_{C} } = \frac{( M - 1 ) {N}_{A} LQ}{{N}_{C}} \cdot {f}_{C} bps$$

When taking chip as unit (N_{C}=1,l=N),then the highest system capacity achieves is N_{A}L(M−1)Qf_{C}/bps.

The system bandwidth calculation:
(1), if T_{C} Δ, namely, when the channel is AWGN or flat frequency decline, the orthogonal characteristic among carriers can be satisfied if only the carrier spacing equal to chip rate f_{C} (or integral multiple) under the condition that the system bandwidth is not limited. All sub-carrier signal's spectrum has half overlapping when the number is F_{C}, and the system bandwidth is the total overlapping bandwidth. It is well known that carrier spacing is chosen like that in OFDM in order to be similar to bandwidth without limitation where the system only filters on the total signal instead of the subcarrier. As long as the number of subcarrier is big enough, it can be close to the bandwidth without limitation. Then, the system bandwidth product of the average time approaches to 1.
(2) if T_{c}<Δ, i.e. the channel is frequency selective fading channel, it will be totally different. Interference must happen if the sub-carrier signal's spectrum is overlapped. So the subcarrier signal needs to be filted and the carrier spacing must be more than f_{C}, otherwise it is hard to ensure the orthogonality. For this case, the system bandwidth should be the total bandwidth of each overlapping sub-carrier signal. It finally leads to the following result that it is impossible to make the system average time carrier signal bandwidth product close to 1 in frequency selective channel by using many orthogonal carrier frequency (or carrier group) method.

So we'd better to choose T_{C} Δ just like the OFDM system and sub-carriers as much as possible in using the present invention if only requiring to improve the high frequency spectrum efficiency. The belowing bandwidth calculation is only under the condition that T_{C} Δ, that is to say, the system bandwidth is the bandwidth between zeros at overlapping frequency spectrum under the condition of flat frequency decline, with minimal intervals between carriers fc:

1. when the minimal intervals between L subcarriers in matrix A is fc

B₁=M(L−1)f_{c}+(M+1)f_{c}=(ML+1)f_{c} Hz,

2. when the minimal intervals between L subcarriers in matrix A is 0.5 fc (calculating based on the main disc)

$${B}_{2} = \frac{M}{2} ( L + 3 ) Hz ,$$

when T_{C}<Δ, bandwidth calculation is related to the chosen filter, and it is unnecessary to go into details.

calculating system frequency spectrum efficiency:

when the intervals between subcarriers in A is Δf=f_{C},

$${η}_{1} ≅ \frac{R}{{B}_{1}} = \frac{{N}_{A} ( M - 1 ) LQ}{{N}_{C} ( ML + 1 )} {}^{ML 1} \frac{{N}_{A}}{{N}_{C}} Q bps / Hz ,$$

Max η₁=N_{A}Q bps/Hz.

when the intervals between subcarriers in A is Δf=0.5f_{C},

$${η}_{2} ≅ \frac{M - 1}{M} \cdot \frac{L}{L + 3} \cdot 2 \frac{{N}_{A}}{{N}_{C}} Q {}^{ML 1} \frac{L}{L + 3} \cdot 2 \frac{{N}_{A}}{{N}_{C}} Q bps / Hz$$

Max η₁=2N_{A}Q bps/Hz.

The mutual shift of basic grouping perfect orthogonal complementary code pair mate is NC=NA, l=N/N_{C}, system frequency spectrum efficiency is not related to overlap weight l, whose signature sequence's utilization is 1 and not related to basic code length, then the width of code groups' ZCW is (NA−1)TC, naturally,

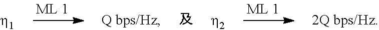

It is well known that the OFDM frequency spectrum efficiency is also Q bps/Hz when number of carrier frequency M 1, which only equals to η₁. where, Δf=0.5f_{C} is the situation permitted by OFDM, and ZCW is impossible to appear.

When the shift is processed by unit of chips N_{C}<N_{A}, system frequency spectrum efficiency will increase with the increasing of overlapping weight l, while the maximum frequency spectrum efficiency appear on the case that shife processed by unit of chips (N_{C}=1, l=N). The maximum frequency spectrum efficiency will increase with increasing the columns number NA of expanded matrix A. We can obtain high frequency spectrum efficiency even ojust using low dimensional (small Q) modulation signal. Obviously, the existing OFDM and other technologies are absolutely impossible to achieve it.

Besides, the bigger the number of orthogonal carrier M1 in subf-rame, the higher the system frequency spectrum efficiency is, but the value of M1 should meet the condition M₁NT_{C}T_{C} [symbol] in practical system, where, [symbol] is the channel's coherent time, determined by working frequency and moving speed.

To achieve network requirements, the present invention considers using the following method: firstly, using shift signature sequence group to form sub-frame, which is serial in time and modulated by M1 orthogonal carrier frequency (or carrier group), then M2 sub-frames make up a frame, and the orthogonal carrier frequency (or carrier group) in all the sub-frame are orthogonal mutually. The system needs M=M1M2 orthogonal carrier frequency (or carrier group).

Second, implement Orthogonal time-frequency coding on the M₂(M₂≧4) sub-frame which are orthogonal mutually in frequency domain, and distribute the different Orthogonal time-frequency coding to different area, which is different Orthogonal sub-frame to make the ICI zero or decline to minimum degree.

The number of orthogonal sub-frame M2 in frequency domain depends on frequency reuse coefficient. According to the principle of four color, M₂≧4, at least four groups of orthogonal carrier frequency (or carrier group) can realize network requirements.

Step 1: list the most basic design parameters and restrictive conditions and so on according to the given channel parameters, and the system parameters:
1. Channel parameters: there is channels' maximum amount of time diffusion Δ (second) or channels' Coherent bandwidth

$${Ω}^{o} = \frac{1}{Δ}$$

(Hz); channels' maximum frequency diffusion

$${F}^{o} ( Hz )$$

or channels' coherent time

$${t}^{o} = \frac{1}{{F}^{o}} ( second ) ;$$

employed band (GHz); Moving speed (Km/Hr,KM/H) and so on.
2. System parameters: mostly are system bandwidth B (Hz,H), the threshold'SNR, SIR, Spectrum efficiency η, cover, Cellular network requirements and so on.

The basic design parameters:

The number of Basic modulation level is 2^{Q}, where, Q is the information bits loaded by each code;

Chip length TC, or chip rate f_{C}=1/T_{C};

Basic grouping complementary code length is NT_{C};

Basic K×N_{A} order extended matrix A (the carrier number L including A);

Number of orthogonal carrier (group) in sub-frame is M1;

Number of orthogonal carrier (group) in frequency domain is M2;

The weight of the overlapping reuse^{l(l≧2)} or shift chips number NC (l=N/N_{C}); NA/NC (1≦N_{A}/N_{C}≦N_{A} is not recommended in the present invention) is the code utilization. When it is more greater, the improvement multiples of system spectrum efficiency is bigger. (NC−1)TC is the width of zero correlation window of the signature sequence group.

The premise condition needs be satisfied among these parameters:

(i) (N−l)T_{C}≧lΔ, (l≧2), or (NC−1)TC>Δ, because of the adjacent shift code group intervals must be greater than the maximum time maximum time diffusion;

ii) M₁NT_{C} [symbol] , which is the basic condition, when C,S part of grouping complete orthogonal complementary code dual is arranged, M1(M1≧2) orthogonal frequency carrier frequency (or carrier frequency group) composed of code length must be satisfied (because the C, S part of the same orthogonal carrier frequency (or the carrier frequency) code group must have the same fading characteristic after transmitted through channels, or it is hard to reflect the complementation property of the mutual complementing code);

iii) M₂≧4, the greater M2 is, the smaller of the ICI i, and M equals to 4, which is the minimum frequency reuse coefficient required by the 4-color principle.

The above eight design parameters are restricted mutually when the system bandwidth B is fixed, so we should combine them repeatedly and choose them wisely.

Step 2: Determine system code words' utilization according to the requirement of system frequency spectrum efficiency.

Because NA<NC is not recommoned in the present invention, the ratio refers to code words' utilization when N_{A}/N_{C}≧1, and when the ratio and Q are greater, system frequency spectrum efficiency is higher, and the complexity of the system processing is higher. The Maximum ratio is NA, which is the number of expand matrix A's columns. All of these are determined by the requirement of the frequency spectrum efficiency's improvement and tolerance of processing complexity.

Step 3: Determine chip ratio f_{C} (or chip length T_{C}=1/f_{C}) according to the given bandwidth B, the total number of Orthogonal carrier M=M1M2 (M2 is fixed value in network condition) and the number of the carrier L in the expended matrix A (if needed);

1) choosing Tc>Δ, and this system can have the highest frequency spectrum efficiency.

2) choosing T_{C}<Δ, though this system does not have the highest frequency spectrum efficiency, there may have other technical advantages.

When choosing 1), we should determine the number of carrier M1M2,L according to preliminary selection of TC and given B. The process needs to repeat many times before it can be determined finally.

When choosing 2), we must consider the value of the zero correlation window and the filter we determined to use which include the parameters and so on when fixing M1,M2,L through choosing TC.

Step 4: determine NC and NA according to the requirement of width of signature sequence groups' zero correlation window.

The width of system signature sequence groups' zero correlation window is (NC−1)TC, so NC is fixed when the chip rate f_{C} is determined.

1) if choosing Tc>Δ, then we can choose NC=1. We may also choose NC>1, and the system can tolerate larger timing and access error.

2) if choosing TC<Δ, then we should determine NC according to the required system's width of “zero correlation window”.

After determine NC, we may fix NA according to the selected value of NA/NC in step 2.

Step 5: Determine the basic complementary code.

### Choose the Basic Complementary Code.

The sub-step can be subdivided with steps as follows:

1) Determine the basic complementary code's length l′;

The main advantage when l′ take larger values includes:

i) big value of l′ will lead to longer basic code length N=L′N_{A} and bigger system spread spectrum process gain G=N, all of which bring a series of well-known advantages.

ii) the IC's correlated characteristicis relatively good, because the correlated characteristic is not ideal only within the relative displacement |τ|<N_{C}≦N_{A}, and it is ideal in other places. Apparently, when l′ is larger, the range of the unideal is relatively small, which is extremely useful for reducing ACI level and so on.

The main disadvantage when l′ takes smaller values includes:

i) The complexity of the maximum likelihood sequence detection algorithm required by the system increases exponentially with the growth of l;

ii) When N=l′NA becomes longer, maximum orthogonal carrier frequency (or carrier frequency group) M will minish which can produce some negative effect in some cases.

Thus, the practical value of l′ should be determined by both practices and possibilities.

2) According to the relationship

l′=l₀×2^{k}; k=0, 1, 2, . . . .

We should decide the length of a shortest basic complementary code l₀ first. For example, when the required l′=12, then l₀0=3, k=2.

3) or according to the relationship

l′=l₀₁×l₀₂×2^{k+1}; k=0, 1, 2, . . . .

We should decide the length of two shortest basic complementary code l₀₁,l₀₂ first.

For example, when the required l′=30, then l₀₁=3,l₀₂=5 (k=0)

4) Determine length of the shortest codes and the engineering requirements according to 2) or 3), and choose the shortest codes [symbol] at random, with length l₀,

$${\mathring{C}}_{1} = [ {C}_{11} , {C}_{12} , … {C}_{1 {l}_{0}} ] .$$

5) According to the requirement of autocorrelation function of complementary completely, solving the complete complementary code [symbol] , which is complete complementary with [symbol] autocorrelation function through simultaneous mathematical equations.

$${\mathring{S}}_{1} = [ {S}_{11} , {S}_{12} , … {S}_{1 {l}_{0}} ] .$$

The element of [symbol] are solved by the following Simultaneous equations:

$$\begin{matrix}{C}_{11} \cdot {C}_{1 {l}_{0}} = - {S}_{11} \cdot {S}_{1 {l}_{0}} \\ {C}_{11} \cdot {C}_{1 {l}_{0} - 1} + {C}_{12} \cdot {C}_{1 {l}_{0}} = - ( {S}_{11} \cdot {S}_{1 {l}_{0} - 1} + {S}_{12} \cdot {S}_{1 {l}_{0}} ) \\ {C}_{11} \cdot {C}_{1 {l}_{0} - 2} + {C}_{12} \cdot {C}_{1 {l}_{0} - 1} + {C}_{13} \cdot {C}_{1 {l}_{0}} = - ( \begin{matrix}{S}_{11} \cdot {S}_{1 {l}_{0} - 2} + \\ {S}_{12} \cdot {S}_{1 {l}_{0} - 1} + \\ {S}_{13} \cdot {S}_{1 {l}_{0}}\end{matrix} ) \\ ⋮ \\ {C}_{11} \cdot {C}_{12} + {C}_{12} \cdot {C}_{13} + … + {C}_{1 {l}_{0} - 1} \cdot {C}_{1 {l}_{0}} = - ( \begin{matrix}{S}_{11} \cdot {S}_{12} + {S}_{12} \cdot {S}_{13} + \\ {S}_{1 {l}_{0} - 1} \cdot {S}_{1 {l}_{0}}\end{matrix} )\end{matrix}$$

There are many solutions for solving [symbol] according to the above simultaneous equations. We may choose any one to be [symbol] .

Example 1: if

$${\mathring{C}}_{1} = ++ -$$

here, + means+1; − means −1, the solving of the probable [symbol] may have many results, for example: + 0 +; − 0 +; + j +; + −j +; − j −; − −j − and so on.

Example 2: if [symbol] =+++, the probable solution of [symbol] including:

$$\sqrt{2} - 1 , 1 , - \frac{1}{\sqrt{2} - 1} ; \sqrt{2} + 1 , 1 , - \frac{1}{\sqrt{2} + 1} ; a , \frac{- 2 a}{{a}^{2} - 1} , - \frac{1}{a}$$

and so on, where a is any value, which is not equal to +1 or −1.

Example 3: if [symbol] =1, 2, −2, 2, 1;one solution of [symbol] is 1, 4, 0, 0, −1 and so on.

If the primary value of [symbol] is improper, then [symbol] may have no solution; though [symbol] may have solutions sometimes, it is unconvinient to apply to engineering. We can't stop to readjust values of [symbol] until we are satisfied with the values.

6) Because we get two latest length l₀₁,l₀₂ according to 3), we should repeat 4) 5) and solution two pair of value

$$( {\mathring{C}}_{1}^{′} , {\mathring{S}}_{1}^{′} ) and ( {\mathring{C}}_{2}^{′} , {\mathring{S}}_{2}^{′} ) .$$

Where:

$${\mathring{C}}_{1}^{′} = {C}_{11}^{′} , {C}_{12}^{′} , … , {C}_{1 {l}_{01}}^{′} ; {\mathring{S}}_{1}^{′} = {S}_{11}^{′} , {S}_{12}^{′} , … , {S}_{1 {l}_{01}}^{′}$$

$${\mathring{C}}_{2}^{′} = {C}_{21}^{′} , {C}_{22}^{′} , … , {C}_{2 {l}_{02}}^{′} ; {\mathring{S}}_{2}^{′} = {S}_{21}^{′} , {S}_{22}^{′} , … , {S}_{2 {l}_{02}}^{′}$$

Then we can solve the mutual-complementing code

$$( {\mathring{C}}_{1} , {\mathring{S}}_{1} )$$

according to the following rules, which length is 2l₀₁×l₀₂, where:

$$\mathring{{C}_{1}} = [ \mathring{{C}_{1}^{′}} ⊗ \mathring{{C}_{2}^{′}} , \mathring{{S}_{1}^{′}} ⊗ \mathring{{S}_{2}^{′}} ]$$

$$\mathring{{S}_{1}} = [ \mathring{{C}_{1}^{′}} ⊗ {{S}_{2}^{′}}_{\_}^{∘} , {{S}_{1}^{′}}^{\mathring{\_}} ⊗ {{C}_{2}^{′}}_{\_}^{∘} ]$$

All of their length are 2l₀₁×l₀₂.

In the Formula, [symbol] shows Kroneckzer product (Kroneckzer product); • means Pour sequence; • means non-linear, that is to say, nagate the elements's value.

Step 6: Determine Basic Perfect Complete Orthogonal Complementary Code Pair Mate

Sub-step 1: Solving another pair of basic shortest complementary code

$$( {\mathring{C}}_{2} , {\mathring{S}}_{2} )$$

which is completely orthogonal complement with

$$( {\mathring{C}}_{1} , {\mathring{S}}_{1} )$$

solved by 5) 6) in step 5.

$$\{ ( {\mathring{C}}_{1} , {\mathring{S}}_{1} ) ; ( {\mathring{C}}_{2} , {\mathring{S}}_{2} ) \}$$

are called Perfect Complete Orthogonal Complementary code pair mate, that is to say, their each pair of the autocorrelation function of the each other between two close function are ideal from the complementary sense.

Theory and through search have proved that: There is only one of the spouse code with complementary code

$$( {\mathring{C}}_{2} , {\mathring{S}}_{2} )$$

for any Complementary code

$$( {\mathring{C}}_{1} , {\mathring{S}}_{1} ) .$$

Moreover, they meet the following relation:

$$\mathring{{C}_{2}} = k {{S}_{1}^{*}}_{\_}^{∘} ; \mathring{{S}_{2}} = k {\mathring{{C}_{1}^{*}}}_{\_}^{\_} ;$$

Here: Underlined • states pour sequence, namely, sort order is reverse (from tailtohead);

Overlined • states non-linear sequence, namely, the value of all elements take negate (negative) values;
states complex conjugate;
K states Arbitrarily complex constants.

For example, if

$$\mathring{{C}_{1}} = \begin{matrix}+ & + & -\end{matrix} ; \mathring{{S}_{1}} = \begin{matrix}+ & j & +\end{matrix} ;$$

Make k=1, then

$$\mathring{{C}_{2}} = \begin{matrix}+ & - j & +\end{matrix} ; \mathring{{S}_{2}} = \begin{matrix}+ & - & -\end{matrix}$$

It is easy to inspect that the values of their autocorrelation function and cross correlation function are ideal in the sense of complementary.

Sub-step 2: we should find the required perfect complete orthogonal complementary code pair mate, whose length is l′=l₀×2^{k} (k=0, 1, 2, . . . ), which is formed from perfect complete orthogonal complementary code pair mate, whose length is l₀.

If

$$( \mathring{{C}_{1}} , \mathring{{S}_{1}} ) and ( \mathring{{C}_{2}} , \mathring{{S}_{2}} )$$

are perfect complete orthogonal complementary code pair mate, then we can use the following four simple solutions to double their length, but the formed new codes are still perfect complete orthogonal complementary code pair mate.

Way 1: Connecte the short codes according to the following ways

$${C}_{1} = \mathring{{C}_{1}} \mathring{{C}_{2}} ; {S}_{1} = \mathring{{S}_{1}} \mathring{{S}_{2}}$$

$${C}_{2} = \mathring{{C}_{1}} {{C}_{2}}^{\overline{∘}} ; {S}_{1} = \mathring{{S}_{1}} {{S}_{2}}^{\overline{∘}}$$

Way 2: Parity bit of C₁(S₁) is made up of

$${\mathring{C}}_{1} ( {\mathring{S}}_{1} ) and {\mathring{C}}_{2} ( {\mathring{S}}_{2} ) ;$$

parity bit of C₂(S₂) is made up of

$${\mathring{C}}_{1} ( {\mathring{S}}_{1} ) and \overline{{\mathring{C}}_{2}} \overline{( {\mathring{S}}_{2} )}$$

For example: if

$${\mathring{C}}_{1} = [ {C}_{11} {C}_{12} … {C}_{1 {l}_{0}} ] , {\mathring{S}}_{1} = [ {S}_{11} {S}_{12} … {S}_{1 {l}_{0}} ] ; ;$$

$${\mathring{C}}_{2} = [ {C}_{21} {C}_{22} … {C}_{2 {l}_{0}} ] , {\mathring{S}}_{2} = {[ {S}_{21} {S}_{22} … {S}_{2 {l}_{0}} ]}_{∘}$$

$$Then {C}_{1} = [ {C}_{11} {C}_{21} {C}_{12} {C}_{22} … {C}_{1 {l}_{0}} {C}_{2 {l}_{0}} ] , \\ {S}_{1} = [ {S}_{11} {S}_{21} {S}_{12} {S}_{22} … {S}_{1 {l}_{0}} {S}_{2 {l}_{0}} ] ;$$

$${C}_{2} = [ {C}_{11} {\overline{C}}_{21} {C}_{12} {\overline{C}}_{22} … {C}_{1 {l}_{0}} {\overline{C}}_{2 {l}_{0}} ] , \\ {S}_{2} = [ {S}_{11} {\overline{S}}_{21} {S}_{12} {\overline{S}}_{22} … {S}_{1 {l}_{0}} {\overline{S}}_{2 {l}_{0}} ]$$

Way 3: Concatenate the short codes according to the following ways:

$${C}_{1} = {\mathring{C}}_{1} {\mathring{S}}_{1} ; {S}_{1} = {\mathring{C}}_{1} \overline{{\mathring{S}}_{1}}$$

$${C}_{2} = {\mathring{C}}_{2} {\mathring{S}}_{2} ; {S}_{2} = {\mathring{C}}_{2} \overline{{\mathring{S}}_{2}}$$

Way 4: Parity bit of C₁ is made up of [symbol] and [symbol] ; parity bit of S₁ is made up of [symbol] and [symbol] ; parity bit of C₂ is made up of [symbol] ; parity bit of S₂ is made up of [symbol] and [symbol] .

There are many other equivalent methods, and it is unnecessary to go into details here. We can obtain the perfect complete orthogonal complementary code pair mate, whose length is l′ as we needed, if keeping using the above methods.

Step 7: Choice of basic expanding matrix A

The bigger the Column number of A NA is, the higher code utilization and the highest frequency utilization efficiency is. Besides, according to the inventor's previous patent (PCT/CN2006/000947), we may conclude that expand matrix A basic code is an important part to expand zero relevant window “address coding from basic code to interblock. It may ensure that the number of enabled code increases greatly under conditions of the same “window” width. Equivalently, we may make the “zero correlation window” wider under the conditions of available ensured code number.

If the order of the expanded matrix A is K×N_{A}, where, K stands for rows number of the expanded matrix, N_{A} is the Column number.

Generally speaking, rows number K of extended matrix A equals to the number of ISN. The bigger K is, the higher the system spectrum efficiency is. But after K>N_{A}, the SNR and processing complexity is higher.

The bigger the column number of the expanded matrix N_{A} is, the wider the width of the cross correlation function's “zero correlation window” is. We can conclude the following things according to PCT/CN2006/00947: A can be constant matrixor random matrix. The system will automatically generate hidden diversity gain when A is random matrix, the multiple number of Maximum diversity is N_{A}, namely the number of random variables which is the number of time space and frequency. All the random variables are the elements of expanded matrix A. People often ask uncorrelated diversity in the traditional system design processing which lead to code element having no relevant or independent decline, but in certain handlable “space” scope, for example, geographical spatial dimensions, processing time, system available bandwidth, and under these constraint conditions, there'll be restrictions on the number of random elements available with no relevant decline or independent decline. Theory and practice have proved that: we can properly relaxe requirements on the used random element's associations. Professor Li DaoBen proposes e⁻¹ standard in his works: there is almost no difference in performance when correlation between zero and high to e⁻¹ (approximately 0.37). According to the experimental results, correlation may relax to around 0.5, which can achieve higher weight of diversity in a “space” processible range. It is not advisable to further relax correlation, though this may cause higher weight hidden diversity. The truly effective weight diversity increasing is very limited, therefore the relaxation of correlation must be moderate.

Step 7 can be divided as follows:

1) Columns number of extended matrix A N_{A} is the maximum code words efficiency and hidden weight diversity;

2) when A is determined as a random matrix, we should select number of basic “weak” related random variable (the number of code elements) based on the engineering requirement which includes “space” size including available time, frequency, space and system complexity,

3) According to the requirements on system complexity and improving the spectrum efficiency, we may determine K, the number of signature sequence ISN in each group, where K is the rows number of expanded matrix.

4) We should construct basic code extension matrix based on the number of basic “weak” related random variable (the number of code elements) including available time, frequency, space and the rows number K and columns number N_{A} of the needed expansion matrix A.

a) The expanded matrix should be full rank matrix in rows, namely, all row vectors shall be linearly independent;

b) Aperiodic and periodic autocorrelation function of each row vectors should have as ‘small’ as possible secondary peak, for example, absolute value should be less than e⁻¹ (even above 0.5).

c) Aperiodic and periodic autocorrelation function among each row vector should have as ‘small’ as possible secondary peak, for example, absolute value should be less than e⁻¹ (even above 0.5).

### Where:

a) Number of “weak” interrelated random elements in each row vector corresponds to the wireless communication system's hidden weight diversity (there will not be diversity effect when A is constant matrix);

b) Quality of the autocorrelation function of each row vector will determine the quality of corresponding code's autocorrelation function within the “window”;

c) Quality of the cross correlation function of each row vector will determine the quality of corresponding code's cross correlation function within the “window”;

Below are some examples of practical basic extended matrix A:

a) Numbers of rows K and columns N_{A} of coding expanded matrix are as follows: K=N_{A}=2,the basic coding expanded matrix is

$$A 0 = [ \begin{matrix}{a}_{1} & {a}_{2}^{*} \\ {a}_{2} & {\overline{a}}_{1}^{*}\end{matrix} ] ,$$

and this is an orthogonal matrix, where, α₁,α₂ are two spaces or any other extraneous variables, or even two constants. There are no requirements on their co-rrelations when their correlation is 1 (constant matrix or α₁=α₂, that is to say, they are the same extraneous variables), the hidden diversity gain will disappear, which is still beneficial for improving system capacity and spectrum efficiency.

b) Numbers of rows K and columns N_{A} of coding expanded matrix are as follows: K=N_{A}=4

The basic coding expanded matrix is

$$A 0 = [ \begin{matrix}{a}_{1} & {a}_{2} & {a}_{3} & {a}_{4} \\ {a}_{2} & {\overline{a}}_{1} & {a}_{4} & {\overline{a}}_{3} \\ {a}_{3} & {\overline{a}}_{4} & {\overline{a}}_{1} & {a}_{2} \\ {a}_{4} & {a}_{3} & {\overline{a}}_{2} & {\overline{a}}_{1}\end{matrix} ]$$

This is still an orthogonal matrix, where, α₁,α₂,α₃,α₄ may be any space or other extraneous variable or new diversity random variables combinated by them, or partly stochastic variable partly constant or even random constants.

c) Columns of multicarrier's coding extension matrix in groups is N_{A}, the rows number is K=LN_{A}, where, L is the number of carriers in groups.

The basic form of the expanded matrix is:

$$A = [ \begin{matrix}{A}_{0} cos ( 2 π {f}_{0} t + {ϕ}_{0} ) \\ {A}_{0} cos ( 2 π ( {f}_{0} + Δ f ) t + {ϕ}_{1} ) \\ ⋮ \\ {A}_{0} cos ( 2 π ( {f}_{0} + ( L - 1 ) Δ f ) t + {ϕ}_{L - 1}\end{matrix} ]$$

Where, A0 is the orthogonal matrix, which order is N_{A}×N_{A},

f₀,f₀+Δf, . . . , f₀+(L−1)Δf are L carriers in groups, φ₀,φ₁, . . . ,φ_{L-1} are their corresponding phases, then A is the matrix with LN_{A}×N_{A} order. Using many carriers is to increase the capacity of the system and the spectrum efficiency. Obviously, when Δf=1/T_{C}, A is still an orthogonal matrix, and so there is no good for improving spectrum efficiency by increasing L.

There are many other basic practical available coding extended matrixs, and it is unnecessary to mention again. We can use all of them as long as they meet the above 3 basic conditions, even including constant matrix. But it is necessary to mention that, constant coding extension matrix A is useful to improve the system spectrum efficiency and increase system capacity, but it does not help in improving system transmission reliability.

Step 8: ConstituteBasic Grouped Perfect Complementary Orthogonal Code pair Mate.

Basic Grouped Perfect Complementary Orthogonal Code pair Mate Bⱼ=Cⱼ[+]Sⱼ(j=1,2) is formed from Kronecker product of bj and A, where,

$${{b}^{0}}_{j} = {{c}^{0}}_{j} [ + ] {{s}^{0}}_{j} ( j = 1 , 2 )$$

is Basic Complementary Orthogonal Code pair Mate, which determined by step 6,A is expanded matrix determined by Step 7,

That is to say,

$${B}_{j} = {{b}^{0}}_{j} ⊗ A ,$$

where, lengthes of Cⱼ, Sⱼ are all N.

The Basic Grouped Perfect Complementary Orthogonal Code pair Mate in the present invention seems like the code mentioned by inventor DaoBen Li in PCT/CN2006/000947, but they are really different, because there is no need to have the zero tail part (or head) in the present invention.

Step 9: Modulate the C and S part of basic grouping perfect orthogonal complementary code pair mate to the M corresponding orthogonal carrier frequency (or carrier groups) following designed number of orthogonal carrier, then link them up in time, and finally, link the C and S part alternately after linking and arranging the M orthogonal carrier frequency, for example:

$$\underbrace{\begin{matrix}{C}_{{f}_{1}} & {C}_{{f}_{2}} & … & {C}_{{f}_{M}}\end{matrix}}_{M} \underbrace{\begin{matrix}{S}_{{f}_{1}} & {S}_{{f}_{2}} & … & {S}_{{f}_{M}}\end{matrix}}_{M} \underbrace{\begin{matrix}{C}_{{f}_{1}} & {C}_{{f}_{2}} & … & {C}_{{f}_{M}}\end{matrix}}_{M} \underbrace{\begin{matrix}{S}_{{f}_{1}} & {S}_{{f}_{2}} & … & {S}_{{f}_{M}}\end{matrix}}_{M} …$$

Where:

$$( {C}_{{f}_{m}} , {S}_{{f}_{m}} )$$

is basic grouping perfect orthogonal complementary code pair mate, which is modulated on the carrier frequency (or carrier groups),

fₖ⊥fₗ,∀l≠k(l,k=0, 1, . . . ,M−1), namely, each carrier frequency (or carrier group) is mutually orthogonal.

Times of C,S repeat links as totally determined by the designed frame size of the system, but there must be even numbers C,S, otherwise, it is hard to reflect features of complementary code. At the same time, “code tail” should be plused, which is caused by continuous shift of code groups, and it equals to [M−(1+1/l)]NT_{C}.

The above C,S part of basic grouping perfect orthogonal complementary code pair mate is arranged on TDD style, if it is totally synchronous for the fading channel to two orthogonal polarization waves component, while at the same time, channel's polarization effect hasn't been expuncted, then the above C,S part of basic grouping perfect orthogonal complementary code pair mate may be modulated on the two orthogonal polarization waves.

Step 10: Implement continuous shift on the linked modulation basic grouping perfect orthogonal complementary code pair mate in step 9, the adjacent shift interval is NT_{C}/1, and times of maximum displacement is l(M−1).

All the basic grouping perfect orthogonal complementary code pair mate can load transmitted information independently or jointly, which modulated by different shift (including zero shift) and different orthogonal carrier frequency (or carrier groups) fₘ(m=0, 1, . . . , M−1).

Step 11: In order to produce more signature sequence group, we should expand the code's length and number, taking the basic grouping perfect orthogonal complementary code pair mate modulated by different shift (including zero shift) and different orthogonal carrier frequency (or carrier groups) fₘ(m=0, 1, . . . , M−1) as Kernel or Root.

According to spanning tree method in the aforementioned previous Patent No. PCT/CN2006/000947, we should expand the basic grouping perfect orthogonal complementary code pair mate's (note: there is no longer need to supplement extra patch 0 matrix) length and number for the same carrier frequency (or carrier group) fₘ(m=0, 1, . . . , M−1), whose distance is M1NTC. The expanded signature sequence will have hidden diversity weight, corresponding to the random variables' species and number. If elements of the basic coding expanded matrix A are composited with the random variables which are “weak” correlation diversity. Simultaneously, There is a “zero correlation window” around the origin among the signature sequence in different code group, the width of which is determined by shift chips number of shift grouping perfect orthogonal complementary pair mate.

It is possible that the basic coding expanded matrix A is a random matrix. Only in the base stations, different address users may use the same extended matrix A. But for address users in different mobile stations, when the basic coding matrix is random matrix, it is absolutely impossible to be the same matrix. In this case, can we still guarantee the properties of “zero related window” among each group pair mate's cross correlation function? The answer is yes. Theory and practice have proved that as long as the extended matrix used by the address users' signature sequence is Homomorphic matrices, then the grouping signature sequence's “zero relevant window” and other properties will retain and not be destroyed. Homomorphic matrices are the matrix with structural form on all fours while the elements are not the same. For example,

$$[ \begin{matrix}{a}_{1} & {a}_{2} \\ {a}_{2} & \overline{{a}_{1}}\end{matrix} ] and [ \begin{matrix}{b}_{1} & {b}_{2} \\ {b}_{2} & \overline{{b}_{1}}\end{matrix} ]$$

are Homomorphic matrices, where, α₁,α₂ and b₁,b₂ can be totally different. Another example,

$$[ \begin{matrix}{a}_{1} & {a}_{2} & {a}_{3} & {a}_{4} \\ {a}_{2} & \overline{{a}_{1}} & {a}_{4} & \overline{{a}_{3}} \\ {a}_{3} & \overline{{a}_{4}} & \overline{{a}_{1}} & {a}_{2} \\ {a}_{4} & {a}_{3} & \overline{{a}_{2}} & \overline{{a}_{1}}\end{matrix} ] and [ \begin{matrix}{b}_{1} & {b}_{2} & {b}_{3} & {b}_{4} \\ {b}_{2} & \overline{{b}_{1}} & {b}_{4} & \overline{{b}_{3}} \\ {b}_{3} & \overline{{b}_{4}} & \overline{{b}_{1}} & {b}_{2} \\ {b}_{4} & {b}_{3} & \overline{{b}_{2}} & \overline{{b}_{1}}\end{matrix} ]$$

are also Homomorphic matrices, where, α₁,α₂,α₃,α₄ may have nothing to do with b₁,b₂,b₃,b₄.

The expanded coding matrix in the same code group can be the same matrix (for example, applying in the base station), and also may be Homomorphic matrix (for example, applying in the mobile station), but we must ensure that the same address' coding expanded matrix in code group is the same matrix whatever the situation is.

In order to obtain signature sequence group with different length and number, we should take the complementary code group

$$( \begin{matrix}{C}_{{f}_{m}} & {S}_{{f}_{m}}\end{matrix} )$$

as the “root”, which is modulated by one or divers orthogonal carrier frequency (or carrier groups) fₘ(m=0, 1, . . . , M−1) then continuously implement orthogonal coding extension in time and frequency domain, for example:

Hardmard Orthogonal Expansion

$${H}_{n} = {H}_{n - 1} ⊗ [ \begin{matrix}+ & + \\ + & -\end{matrix} ] , n = 1 , 2 , …$$

Where, H₀ is orthogonal expansion's “root”. It can be the complementary code pair group

$$( \begin{matrix}{C}_{{f}_{m}} & [ + ] & {S}_{{f}_{m}}\end{matrix} ) ,$$

which is modulated by any one orthogonal carrier frequency (or carrier groups), or it may be the original matrix composed by complementary code pair group, which is modulated by two or more different orthogonal frequency (or carrier groups). Every stage, the number and length of the code group in former stage will be doubled, the code group is orthogonal in pre-and post expansion, further more, they all have the same “zero correlation window”.

There are many other types of orthogonal extension transformation. They are basically equivalent in mathematics, so it is unnecessary to go further.

The order of Step 10 and 11 can change, that is to say, we may expand the number and length of the signature sequence group firstly, then implement continuous overlap shift, or we may implement continuous overlap shift first, then expand the number and length of the signature sequence group.

Method of “zero correlation window” LAS-CDMA multi-address coding invented by LiDaoBen in PCT/CN00/0028 is only the special case in the present invention, when the expanded matrix A is 1×1 matrix (constant) and without relative shift. Method of “Zero correlation window” between groups DBL-CDMA grouping multiaddress coding in PCT/CN2006/000947 is also only the special case in the present invention, where basic grouping complete orthogonal complementary code pair mate is supplemented with 0,number of orthogonal carrier M1 is one and without relatively overlap shift.

Step 12: Implement multicode joint sequential detection to the overlapped multiplexing orthogonal multicarrier grouping “zero relevant window” multiaddress signal in the R-x side.

Multicode joint sequential detection may be the maximum likelihood joint sequential detection, the maximum posteriori probability joint sequential detection, and all kinds of prospective optimal algorithm, fast algorithm, and so on. Specific multicode joint detection algorithm can also refer to the present inventor's two previous patents. One of the previous patent number is PCT/CN2006/001585 with title “a time division multiplexing method and system” and the other is PCT/CN2006/002012 with title “a frequency division multiplexing method and system”. There are some things to note in processing multicode joint detection that we need to implement multicode joint sequential detection to load information of C and S part of basic grouping complete orthogonal complementary code dual respectively, and finally, sum up the test results.

The code division multiplexing method and system of the present invention is not meant to be limited to the aforementioned prototype system, and the subsequent specific description utilization and explanation of certain characteristics previously recited as being characteristics of this prototype system are not intended to be limited to such technologies.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

1. A code division multiplexing method, said method comprising:
a) Constructing the basic group perfect orthogonal complementary code pair mate;
b) Modulating the C code and S code of basic grouping perfect orthogonal complementary code pair mate to the M orthogonal carrier frequency (or carrier groups) is are serial in time, and
c) Implementing the continuous shift to the modulated basic grouping perfect orthogonal complementary code pair mate.

2. The method as recited in claim 1 wherein said method comprising expanding the number and length of the code setting the modulated and shifted basic grouping perfect orthogonal complementary code pair mate as the root.

3. The method as recited in claim 2 wherein said method further comprising
a) Loading the information on said modulated and shifted basic grouping perfect orthogonal complementary code pair mate;
b) Implementing multi-code joint sequential detection to the loaded information of said basic grouping perfect orthogonal complementary code pair mate.

4. The method as recited in claim 1 wherein said method further comprising
a) The width of said basic grouping perfect orthogonal complementary code pair mate's window of zero correlation greater than the channel's maximum time diffusion, and the width of the window of zero correlation being (Nc−1)×Tc, where, Nc denoting the number of shift chips and Tc is the length of chip, and
b) After transmitted through channels, said C code and S code of said basic grouping perfect orthogonal complementary code pair mate having the same decline characteristics modulated by the same orthogonal carrier.

5. The method as recited in claim 4 wherein said method comprising
a) Said chip's length determined by the given system bandwidth and
b) Said shift chips' number Nc is equal to or greater than 1 integer in AWGN (additive white Gaussian noise) or flat fading channel determined by the width of the ZCW and sais chip's length Tc in frequency selective fading channel.

6. The method as recited in claim 1 wherein the comprising of said basic group perfect orthogonal complementary code pair mate comprising:
a) Choosing the basic grouping perfect orthogonal complementary code pair mate,
b) Choosing the basic expanded matrix A, and
c) Obtaining said basic grouping perfect orthogonal complementary code pair mate by producing said basic grouping perfect orthogonal complementary code pair mate and the basic expanded matrix A.

7. The method as recited in claim 6 wherein choosing of said basic grouping perfect orthogonal complementary code pair mate further comprising:
a) Determining the length of said basic grouping perfect orthogonal complementary code pair mate l′ according to said width of the ZCW of the system,
b) Determining the shortest length of said basic grouping perfect orthogonal complementary code pair mate l₀, according to the relation l′=l₀×2^{k}, where, k=0, 1, 2, . . . ;
c) Choosing the code [symbol] according to engineering requirements with shortest length is l₀, and
$${\mathring{C}}_{1} = [ {C}_{11} , {C}_{12} , … {C}_{1 {l}_{0}} ] ;$$
d) Solving the code [symbol] , which is totally complementary with the autocorrelation function of [symbol] according to the request of the autocorrelation function's property of fully complementarities, and
$$\mathring{{S}_{1}} = [ {S}_{11} , {S}_{12} , … {S}_{1 {l}_{0}} ] ,$$
e) Solving another shortest basic complementary code
$$( \mathring{{C}_{2}} , \mathring{{S}_{2}} )$$
which is totally orthogonal complement with
$$( \mathring{{C}_{1}} , \mathring{{S}_{1}} )$$
according to the shortest basic complementary code
$$( \mathring{{C}_{1}} , \mathring{{S}_{1}} ) ,$$
and
f) Forming complete orthogonal complementary code pair mate with length l′=l₀×2^{k} from the complete orthogonal complementary code pair mate with length l₀.

8. The method as recited in claim 6 wherein choosing of said basic grouping perfect orthogonal complementary code pair mate further comprising:
a) Determining the shortest length of said basic grouping perfect orthogonal complementary code pair mate l′ according to said width of the ZCW,
b) Determining the two shortest lengths of basic complementary code l₀₁,l₀₂ based on the relation l′=l₀₁×l₀₂×2^{k+1}, where, k=0, 1, 2, . . . ,
c) Choosing two shortest code [symbol] and [symbol] , with length l₀₁ and l₀₂,and according to engineering requirements, where,
$$\mathring{{C}_{1}^{′}} = {C}_{11}^{′} , {C}_{12}^{′} , … , {C}_{1 {l}_{01}}^{′} , \mathring{{C}_{2}^{′}} = {C}_{21}^{′} , {C}_{22}^{′} , … , {C}_{2 {l}_{02}}^{′} ;$$
d) Solving the code [symbol] and [symbol] which are totally complementary with the autocorrelation function of [symbol] and [symbol] , according to the request of the autocorrelation function's property of fully complementarily,
e) Solving the complementary code by following the below rules with length 2l₀₁×l₀₂, where,
$$\mathring{{C}_{1}} = [ \mathring{{C}_{1}^{′}} ⊗ \mathring{{C}_{2}^{′}} , \mathring{{S}_{1}^{′}} ⊗ \mathring{{S}_{2}^{′}} ] \mathring{{S}_{1}} = [ \mathring{{C}_{1}^{′}} ⊗ {{S}_{2}^{′}}_{\_}^{∘} , {{S}_{1}^{′}}^{\mathring{\_}} ⊗ {{C}_{2}^{′}}_{\_}^{∘} ] ,$$
f) Solving another pair of shortest basic complementary code
$$( \mathring{{C}_{2}} , \mathring{{S}_{2}} ) ,$$
which is totally orthogonal complementary with
$$( \mathring{{C}_{1}} , \mathring{{S}_{1}} ) ,$$
according to the shortest basic complementary code
$$( \mathring{{C}_{1}} , \mathring{{S}_{1}} ) ;$$
g) Forming complete orthogonal complementary code pair mate with length l′=l₀₁×l₀₂×2^{k+1}; k=0, 1, 2, . . . from the complete orthogonal complementary code pair mate with length is 2l₀₁×l₀₂.

9. The method as recited in claim 7 wherein in order to form the complete orthogonal complementary code pair mate with length l′, we can double said lengths of two shortest basic complementary code
$$( \mathring{{C}_{1}} , \mathring{{S}_{1}} ) and ( \mathring{{C}_{2}} , \mathring{{S}_{2}} )$$
continuously.

10. The method as recited in claim 9 wherein getting said doubled lengths comprising:
a) Method 1:
$${C}_{1} = \mathring{{C}_{1}} \mathring{{C}_{2}} , {S}_{1} = \mathring{{S}_{1}} \mathring{{S}_{2}} , {C}_{2} = \mathring{{C}_{1}} {{C}_{2}}^{\overline{∘}} , {S}_{1} = \mathring{{S}_{1}} {{S}_{2}}^{\overline{∘}} ,$$
or
b) Method 2: parity bit of C₁(S₁) made up of
$$\mathring{{C}_{1}} ( \mathring{{S}_{1}} ) and \mathring{{C}_{2}} ( \mathring{{S}_{2}} )$$
and parity bit of C₂(S₂) made up of
$$\mathring{{C}_{1}} ( \mathring{{S}_{1}} ) and \overline{\mathring{{C}_{2}}} ( \overline{\mathring{{S}_{2}}} ) ,$$
or
c) Method 3:
$${C}_{1} = \mathring{{C}_{1}} \mathring{{S}_{1}} , {S}_{1} = \mathring{{C}_{1}} {{S}_{1}}^{\overline{∘}} , {C}_{2} = \mathring{{C}_{2}} \mathring{{S}_{2}} , {S}_{2} = \mathring{{C}_{2}} {{S}_{2}}^{\overline{∘}} ,$$
or
d) Method 4: parity bit of C₁ made up of
$$\mathring{{C}_{1}} and \mathring{{S}_{1}} ,$$
and parity bit of S₁ made up of [symbol] and, and parity bit of C₂ made up of [symbol] and [symbol] , and parity bit of S₂ made up of [symbol] and [symbol] .

11. The method as recited in claim 5 wherein choosing of said basic expanded matrix including further comprising:
a) Choosing basic weak related random variables according to the requirements of the engineering requirement, which includes space size including available time, frequency, space and system complexity;
b) Determining the ISN's number of said basic group perfect orthogonal complementary code pair mate K according to the requirement of spectrum effectiveness and system complexity which is the rows number of expanded matrix A,
c) Determining the columns number of matrix A NA according to the requirement of system spectrum effectiveness and the number of shift chips Nc,
d) Constructing the basic coding expanded matrix according to said weak related random variables, the rows and columns number of expansion matrix A.

12. The method as recited in claim 11 wherein said rows number of expansion matrix K=NA.

13. The method as recited in claim 11 wherein said number of ISN is K=LNA when the ISN of basic grouping perfect orthogonal complementary code pair mate is multicarrier where L is the number of carriers in group, and NA is the columns number of matrix A.

14. The method as recited in claim 11 wherein said method further comprising:
a) Said expansion matrix being full rank matrix in rows and all row vectors linearly independent,
b) Aperiodic and periodic autocorrelation function of each row vector having as ‘small’ as possible secondary peak,
c) Aperiodic and periodic autocorrelation function among each row vector should have as ‘small’ as possible secondary peak.

15. The method as recited in claim 1 wherein modulating said C code and S code of said basic grouping perfect orthogonal complementary code pair mate to said M orthogonal carrier frequency (or carrier groups) serial in time, said method further comprising:
a) Using said basic grouping perfect orthogonal complementary code pair mate modulated by M1 orthogonal carriers frequency (or carrier group) and seriating in time from the subframe,
b) Forming the frame from M2 orthogonal subframes in frequency domain, and
c) Implementing orthogonal time and frequency codes on the M2 orthogonal frames in frequency domain, and M=M₁M₂.

16. The method as recited in claim 15 wherein said method further comprising:
a) When single cell not in networking: M₂=1, M=M₁,
b) When single cell in networking, M₂ is equal to or greater than 4.

17. The method as recited in claim 2 wherein said expanding method comprising:
a) Spanning tree method to expand the code's length and number of said basic grouping perfect orthogonal complementary code pair mate having the same carrier frequency, or
b) Implementing continuously time and frequency orthogonal coding based on sasi basic grouping perfect orthogonal complementary code pair mate modulated by one or many orthogonal carrier frequency as the root.

18. The method as recited in claim 3 wherein implementations of multicode joint inspection on the information loaded on said basic grouping perfect orthogonal complementary code pair mate further comprising:
a) Implementing multicode joint sequential detection on the loading information of C and S of basic group complete orthogonal complementary code dual respectively, and
b) Summing up the test results.

19. The method of code division multiplexing, said system comprising:
a) Code block generator to construct the basic grouping perfect orthogonal complementary code pair mate,
b) Carrier modulator to modulate the C code and S code of said basic grouping perfect orthogonal complementary code pair mate to the M orthogonal carrier frequency or orthogonal polarization waves sedate in time, and
c) Shifter to implement continuous shift on the modulated basic grouping perfect orthogonal complementary code pair mate.

20. The method as recited in claim 19 wherein said system further comprising:
a) Coding expand device to expand the code's length and number based on said basic grouping perfect orthogonal complementary code pair mate modulated and shifted as the root,
b) Data modulator to load the information on said basic grouping perfect orthogonal complementary code pair mate shifted and expanded, and
c) Detector to implement multicode joint sequential detection to the information loaded on said basic grouping perfect orthogonal complementary code pair mate.
